(19) United States
(12) Patent Application Publication
(10) Pub. No.: US 2008/0316551 A1
(43) Pub. Date: Dec. 25, 2008

(54) AUTOMATED PAGE TURNING APPARATUS TO ASSIST IN VIEWING PAGES OF A DOCUMENT

(75) Inventors: Thomas N. Taylor, Rochester, NY (US); Lotfi Belkhir, Victor, NY (US); Ahmed-Mohsen Shehata, Penfield, NY (US); Kevin Maurer, Farmington, NY (US); Brian Kehoe, Rochester, NY (US); Jeffrey C. Blood, Victor, NY (US); Randall Ryon, Victor, NY (US); Robert Savage, Honeoye Falls, NY (US); Kenneth J. Rieck, Victor, NY (US)

Correspondence Address: BASCH & NICKERSON LLP, 1777 PENFIELD ROAD, PENFIELD, NY, 14526, US

(73) Assignee: Kirtas Technologies, Inc., Victor, NY (US)

(21) Appl. No.: 12/143,072

(22) Filed: Jun. 20, 2008

Related U.S. Application Data
(63) Continuation-in-part of application No. 10/658,956, filed on Sep. 10, 2003.
(60) Provisional application No. 60/945,382, filed on Jun. 21, 2007.
(60) Provisional application No. 60/409,399, filed on Sep. 10, 2002.

(51) Int. Cl. H04N 1/04

(52) U.S. Cl. 358/498

(57) ABSTRACT

Disclosed is a method and apparatus for the viewing and acquisition of images of a document such as a book, including the automated and reliable turning of pages of the document, while supporting it in a manner to facilitate viewing or imaging of the facing pages.

This application is a continuation-in-part application, and claims priority from co-pending U.S. patent application Ser. No. 10/658,956 for an “AUTOMATED PAGE TURNING APPARATUS TO ASSIST IN VIEWING PAGES OF A DOCUMENT,” filed Sep. 10, 2003, and thereby from U.S. Provisional Application 60/409,399 filed Sep. 10, 2002, both of which are hereby incorporated by reference in their entirety. Priority is also claimed from U.S. Provisional Application No. 60/945,382 for an “AUTOMATED PAGE TURNING APPARATUS TO ASSIST IN VIEWING PAGES OF A DOCUMENT,” filed Jun. 21, 2007, which is also incorporated by reference in its entirety.

This disclosure relates generally to an apparatus for use in viewing, reading or imaging pages of a document, and more particularly to an automated apparatus that facilitates viewing or reading of a book, or enables acquisition of book-like page images, wherein the book or document is held in a fixture, and each page is sequentially turned, precisely positioned, and presented to either a human reader, or an image acquisition system. Such an apparatus may be employed so that the information content of the document may be assembled in analog or digital form for subsequent storage, distribution, and/or reprinting.

### CROSS-REFERENCE TO RELATED APPLICATIONS

The following related applications are hereby incorporated by reference for their teachings:

“AUTOMATED APPARATUS TO ASSIST IN BOOK READING,” Thomas N. Taylor et al., Application No. 60/409,399, filed Sep. 10, 2002; and

“PAGE TURNING APPARATUS WITH A VACUUM PLENUM AND AN ADAPTIVE AIR FLUFFER,” Lotfi Belkhir, application Ser. No. 10/389,051, filed Mar. 14, 2003.

### BACKGROUND AND SUMMARY

A number of automated or semi-automated book scanning or reading systems are presently known in the art of book imaging, recording, and electronic archiving. In the use of such systems, a book is typically held in an open state, and a digital image of each page in sequence is acquired through either a digital camera, or an LED based scanner. One main function of such systems is to turn, and thereby expose to an imaging system, every page of a book in sequence.

It will be appreciated that a book or similar document reading system must overcome various problems. It is particularly desirable that a book reading system be capable of reading a large majority of books that are candidates for conversion to electronic format. For example, such a book reading system has utility in public and university libraries. Accordingly, a book reading system in such an application must be able to reliably read books with a wide range of physical properties or characteristics, without damaging such books.

Among the properties and conditions that an optimal book reading apparatus must accommodate are the following:
a) Physical size, i.e. the length and width of the book leaves, and the book cover board, if present.
b) Physical thickness of the book, i.e. substantially the number of leaves of the book, times the thickness of each page.
c) The thickness and paper composition of each leaf, and the properties related thereto (e.g., mass, stiffness, porosity, and the like).
d) The existence and characteristics such as elasticity of the book spine, i.e. whether the book spine remains flat when the book is opened, or whether it forms an arch, and to what extent it arches (radius of curvature). Alternatively, the leaves (pages) may be “bound” in a three-ring binder, or may simply be loosely assembled together without a binding.
e) The stiffness and support properties of the cover board on a hardcover book, versus the absence thereof on a paperback book.
f) The presence of anomalies in the structure of the book, such as a broken, creased, or split binding, rough-edged leaves, or other wear-and-tear, which result in variation in the properties of the book from leaf to leaf. Such anomalies would be considered as a source of noise in the art of statistical process control.
g) Variation in ambient conditions, such as relative humidity, which result in variability in the properties of the leaf paper, due to moisture absorption and desorption. Such variability would also be a source of noise to be accommodated by the book reading apparatus.

In addition to accommodating the variability from book-to-book, an automated book reading apparatus must also accommodate the variation in page location during the transition of open page location from the front of the book, to the back of the book. If an open book is held with its front and back covers in a fixed position, and the pages are sequentially turned, the physical location of the open pages will change due to the cumulative effect of the leaves being displaced from one side of the book to the other side, and also due to variation in leaf curvature, with respect to open page location.

Heretofore, a number of patents and patent applications have disclosed apparatus for book positioning and/or page turning, used in book reading, imaging, and recording, the relevant portions of which are hereby incorporated by reference for their teachings, and which may be briefly summarized as follows:

U.S. Pat. No. 6,264,188 B1 to Taylor et al, issued Jul. 24, 2001, discloses a sheet feeding apparatus having an adaptive air fluffer and an air plenum, which operate together to separate a top sheet from a stack of sheets therebelow.

U.S. Pat. No. 6,279,896 B1 to Linder et al, issued Aug. 28, 2001, discloses a sheet feeding apparatus including a vacuum source that is selectively actuable, a translating vacuum feed head attached to the vacuum source to acquire the top sheet of the stack, a unidirectional rotating drive mechanism, and a control circuit, which dynamically adjusts vacuum and positive pressures to ensure proper sheet feeding.

U.S. Pat. No. 6,398,206 B1 to Taylor et al, issued Jun. 4, 2002, discloses a sheet feeding apparatus having an air plenum with a corrugated surface, comprising a first set of ribs at a first height and a second set of ribs at a second height, which corrugates and separates a top paper sheet from a stack of paper sheets therebelow, regardless of the weight of the paper stock of the sheets.

U.S. Pat. No. 6,398,208 B1 to Taylor et al, issued Jun. 4, 2002, discloses a sheet feeding apparatus having an air plenum with a corrugated surface and with a leaky perimeter seal, which corrugates and separates a top paper sheet from a stack of paper sheets and seals thereto.

Some aspects of the present disclosed embodiments are directed to the application of a vacuum plenum having a corrugated surface as an aid to the separation and turning of pages in an open-book scanner. Scanners of the type in which the present application find a particular use are described, for example, in the following patents U.S. Pat. No. 6,056,258, U.S. Pat. No. 5,640,252 and U.S. Pat. No. 5,359,207. These patents and applications are hereby incorporated by reference into this specification for their teachings related to page turning, scanning and/or vacuum handling of paper sheets and pages.

It is therefore an object of the disclosed systems and methods to provide an automated apparatus to provide for the turning of document pages such as bound books to assist, for example, with book reading. Such an apparatus can reliably present the leaves or pages of a book in sequence to a human reader or an image acquisition system, regardless of the document's length and width, thickness, leaf (page) properties, presence of a spine, spine properties, hard or soft cover, and state of wear-and-tear, and regardless of the ambient conditions in which the apparatus is located.

It is a further object of the disclosed systems and methods to provide an automated apparatus to assist in viewing or reading of pages of the documents, which can attach to, and turn in sequence, every page beginning with a selected first page, and ending with a selected final page.

It is another object of the disclosed systems and methods to provide an automated apparatus to assist in viewing or reading of bound documents, which can present every page in sequence to an image acquisition device, beginning with a selected first page, and ending with a selected final page, wherein every page is located within a field of view and a focal plane of the image acquisition device.

It is an object of the disclosed systems and methods to provide an automated apparatus to assist in book reading, which can reliably present the pages of a book or similarly bound document in sequence to a human reader or an imaging system (for image viewing and/or capture), without damaging the book.

It is an additional object of the disclosed systems and methods to provide an automated apparatus to assist in book reading, which can reliably acquire an image of every page in a book, beginning with a selected first page, and ending with a selected final page.

It is a further object of the disclosed systems and methods to provide an automated book reading apparatus, which can reliably acquire and translate any book into an electronic format at a rate of approximately twenty pages per minute or higher.

It is a further object of the disclosed systems and methods to provide for and assure centering of the document being imaged via controlled movement or alignment of the bound document using one or more sensing techniques to find the page bifurcation point or location.

It is yet another object of the disclosed systems and methods to provide means for smoothing or flattening turned pages.

It is a further object of the disclosed systems and methods to of preventing the turning of multiple pages at one time using mechanical or similar means to retard the turning of subsequent pages.

It is yet another object of the disclosed systems and methods to detect the boundaries or edges of pages or leaves of the book once turned, and various embodiments to accomplish such an object are disclosed.

It is yet a further object of the disclosed systems and methods to provide features that improve or expand the capabilities of the page-turning book scanner described herein, including a page-clear sensor and variation in the cradle design to permit the scanning of over-sized books and other documents.

In accordance with the disclosed systems and methods, there is provided an apparatus that enables acquisition of page images, comprising a base for supporting the operative assemblies and components of the apparatus, a cradle assembly having a first cradle half and a second cradle half, and a page turning assembly for presenting the pages to be imaged seriatim. Each of the cradle halves of the cradle assembly comprises a cradle base joined to a book support plate by a linkage, each cradle half further having a pair of book cover clamps, and a drive motor suitably operatively coupled to the book support plate, such that operation of the drive motor displaces the book support plate in an arcuate manner relative to the cradle base. The support plates of the first and second cradle halves are joined by a flexible web of material. The page turning assembly further comprises a page fluffer for separating an open page from the adjacent pages comprising the text block therebeneath, and a pivotable and translatable vacuum head (adjustable to the book page size) for attaching to the separated open page and turning the separated open page.

In accordance with a further aspect of the disclosed systems and methods, there is provided an apparatus that enables acquisition of page images, further comprising an optical assembly comprising at least one camera, lighting directed at the open pages of the book, sensing means to detect the location of the open pages of the book relative to the field of view and focal plane of the camera, and at least one mirror to direct the images of the left open page and the right open page to the camera during an imaging cycle.

In accordance a further aspect of the disclosed systems and methods, there is provided an apparatus that enables acquisition of page images, further comprising open page securing and flattening means having a first page clamp and a second page clamp, each clamp being retractable prior to page turning and deployable prior to page imaging.

In accordance a further aspect of the disclosed systems and methods, there is provided an apparatus that enables acquisition of page images, further comprising page position adjustment means further comprising at least one motor operatively joined to at least one half of the cradle assembly, in order to horizontally translate the cradle assembly and the book held therein.

In accordance a further aspect of the disclosed systems and methods, there is provided an apparatus that enables acquisition of page images, further comprising page bifurcation position adjustment means further comprising optical sensing means for sensing the position of the page bifurcation of a book held within the cradle assemble of the apparatus.

In accordance a further aspect of the disclosed systems and methods, there is provided an apparatus that enables acquisition of page images, further comprising page edge detection means further comprising optical sensing means for sensing the position of the edge of a page as it is acquired by a vacuum head and turned by a page turning assembly.

In accordance with another aspect of the disclosed systems and methods, there is provided a method of reading, in seriatim, a plurality of pages in the nature of a book comprising the steps of securing the book in a cradle assembly, the book being opened to a selected first and second pages; adjusting the position of the book such that at least one of the first and second pages are entirely within the field of view of at least one image acquisition device; holding the at least one page in position for a period of time; displacing at least the outer edge of the second page from contact with subsequent adjacent pages; temporarily placing a vacuum head proximate to at least a portion of the surface of the second page; acquiring the second page with the vacuum head device; turning the second page about its line of contact with the binding of the book until the printed surface of the second page is substantially congruent with the printed surface of the first page; and releasing the second page from the vacuum head.

In accordance with another aspect of the disclosed systems and methods, there is provided a method of reading, in seriatim, a plurality of pages in the nature of a book comprising the steps of securing the book in a cradle assembly, the book being opened to a selected first and second pages; flattening at least one of the first and second pages of the book, securing at least one of the first and second pages of the book with at least one page clamping device such that said at least one page is within the field of view and focal plane of at least one image acquisition device; adjusting the position of the book such that at least one of the first and second pages are entirely within the field of view of at least one image acquisition device; holding the at least one page in position for a period of time; releasing the page clamping device; displacing at least the outer edge of the second page from contact with subsequent adjacent pages; temporarily placing a vacuum head proximate to at least a portion of the surface of the second page; acquiring the second page with the vacuum head device; turning the second page about its line of contact with the binding of the book until the printed surface of the second page is substantially congruent with the printed surface of the first page; and releasing the second page from the vacuum head.

The apparatus and methods presently described are advantageous because they are capable of being adapted to a wide range of books or similar bound and unbound documents for which it is desired to capture, view and/or record images in seriatim of the pages therein. In particular, the apparatus of the present invention is capable of reliably separating and turning the pages of a document such as a book, and in accommodating the wide variations in geometry between books, as they are held and processed by the apparatus. As a result of the invention, repositories of large volumes of books will have the option of recording, archiving, and distributing the information contained therein in either analog image format, or in exceedingly compact and transmittable digital format.

### BRIEF DESCRIPTION OF THE DRAWINGS

The embodiments will be described by reference to the following drawings, in which like numerals refer to like elements, and in which:

FIG. 1A-1C are perspective views of a book, taken from various angles, which are provided to define terminology used in this specification;

FIG. 2A is a side elevation view of image recording means and of a book, which is open to a page location approximately in the center of the text block;

FIG. 2B is a side elevation view of image recording means and of a book, which is open to a page location near the front cover of the book;

FIG. 2C is a side elevation view of image recording means and of a book, which is open to a page location near the back cover of the book;

FIG. 3A is a perspective view, which depicts means to flatten the pages of a book into substantially planar surfaces;

FIG. 3B is a side elevation view, which depicts means to flatten the pages of a book into substantially planar surfaces;

FIGS. 4A and 4B are a perspective view and an elevation view, respectively, of one embodiment of the automated apparatus.

FIG. 5 is a flow chart of an automated process for acquiring images of the pages of a book, using embodiments disclosed.

FIGS. 6A and 6B are a perspective view and an elevation view, respectively, of a cradle assembly of the apparatus.

FIGS. 7A and 7B are additional elevation views from the left front and right front, respectively, of a cradle assembly.

FIG. 8A is an elevation view of the disclosed cradle assembly, further depicting a book held by the cradle assembly, shortly after the beginning of the page imaging process.

FIG. 8B is an elevation view of the cradle assembly, further depicting a book held by the cradle assembly, shortly before the end of the page imaging process.

FIG. 9A is a front elevation view of the cradle assembly and clamp and cradle adjustment mechanisms housed in the base of the apparatus.

FIG. 9B is a side elevation view of the cradle assembly and clamp and cradle adjustment mechanisms of FIG. 9A.

FIG. 10A is a perspective view of the cradle assembly, further depicting page clamps for flattening the open pages prior to page imaging.

FIGS. 10B and 10C are elevation views of a page clamp in the released position, and the deployed position, respectively.

FIG. 11A is an elevation view of the cradle assembly, further depicting a book held by the cradle assembly, and a page clamp in the released position.

FIG. 11B is an elevation view of the cradle assembly, further depicting a book held by the cradle assembly, and a page clamp in the clamped position.

FIGS. 12A and 12B are a perspective view and an elevation view, respectively, of an optical assembly of the disclosed apparatus.

FIG. 13A is a perspective view of part of the disclosed apparatus, further depicting a cradle assembly, a page fluffing assembly, and a page turning assembly.

FIG. 13B is a perspective view of part of the disclosed apparatus, further depicting a cradle assembly, and a page fluffing assembly.

FIG. 13C is a perspective view of part of the disclosed apparatus, further depicting an alternative embodiment of a cradle support assembly, a clamp assembly, and the page fluffing assembly.

FIG. 14A is a front elevation view of a cradle assembly and a page fluffer of the apparatus, further depicting a book held by the cradle assembly.

FIG. 14B is a top view of the cradle assembly and page fluffing assembly of FIG. 14A.

FIG. 15A is a front elevation view of a cradle assembly and a page turner of the apparatus, further depicting a book held by the cradle assembly.

FIG. 15B is a right front perspective view of a cradle assembly and a page turner of the apparatus.

FIG. 16A is a front elevation view of a cradle assembly and a page turner, depicting the geometric relationships between components thereof, and also depicting an air knife in the page turning assembly.

FIG. 16B is a top view of the cradle assembly and page turning assembly of FIG. 16A, wherein the page turning assembly further comprises retard fingers for ensuring that only a single page is turned by the page turning assembly.

FIG. 17 is an exemplary timing diagram of a disclosed embodiment, which depicts the parallel operations of the various assemblies during the book page imaging process.

FIG. 18 is a sectional view of a cradle assembly of the apparatus, taken at line 18-18 of FIG. 9B, further depicting the use of a spine cloth for supporting a book upon the cradle assembly.

FIG. 19 is a left front perspective view of a cradle assembly and a page turner of the apparatus.

FIG. 20 is a side elevation view of a vacuum head further comprising page edge detection means attached thereto.

FIG. 21 is an elevation view of an alternative optical assembly.

FIG. 22A is an illustration of alternative embodiments for detection of the page bifurcation location in a document.

FIG. 22B is a representation of an image of an end of a book in accordance with an embodiment for detection of the page bifurcation.

FIGS. 23A-H are representations of various orthographic views of front (23A-D) and rear (23E-H) assemblies of an alternative embodiment of the system, including a page snubber, page clamp assemblies with pneumatic page flattening means, and sensors for detecting page bifurcation, as well as an adjustable page fluffer.

FIG. 24 illustrates another pneumatic means for smoothing or flattening turned pages.

FIGS. 25A-D are illustrative examples of an adjustable position vacuum head, that is capable of adjustment between a small page size configuration (FIGS. 25A-B) and a large page size configuration (FIGS. 25C-D).

The following disclosure will be presented in connection with a preferred embodiment(s), however, it will be understood that there is no intent to limit the invention to the embodiments described. On the contrary, the intent is to cover all alternatives, modifications, and equivalents as may be included within the spirit and scope defined by the appended claims.

### DESCRIPTION OF THE PREFERRED EMBODIMENTS

For a general understanding of the present system, reference is made to the drawings. In the drawings, like reference numerals have been used throughout to designate identical elements. In describing the embodiments, a variety of terms are used in the description. Standard terminology is widely used in book manufacturing art, and in library art. For example, one may refer to the web sites “Glossary of Book Terms” at http://www.alibris.com/glossary; and “Glossary of Book Terms Condition, Anatomy, Size & Abbreviations” of the Alibris Corporation of Emeryville, Calif., the disclosures of which are incorporated herein by reference.

Although the term “book” is used herein to describe particular embodiments and aspects of the disclosed embodiments, the term is intended to broadly represent various types of bound documents where the pages thereof are folded and/or connected to one another so as to be viewed or read in seriatim—such as three-ring notebooks, etc. Examples of such documents include sheet music, reports, fanfold computer printouts. It is further anticipated that a series of unbound pages may be handled in a manner similar to that described relative to the following embodiments and that the set of unbound pages would turn about a common edge or axis.

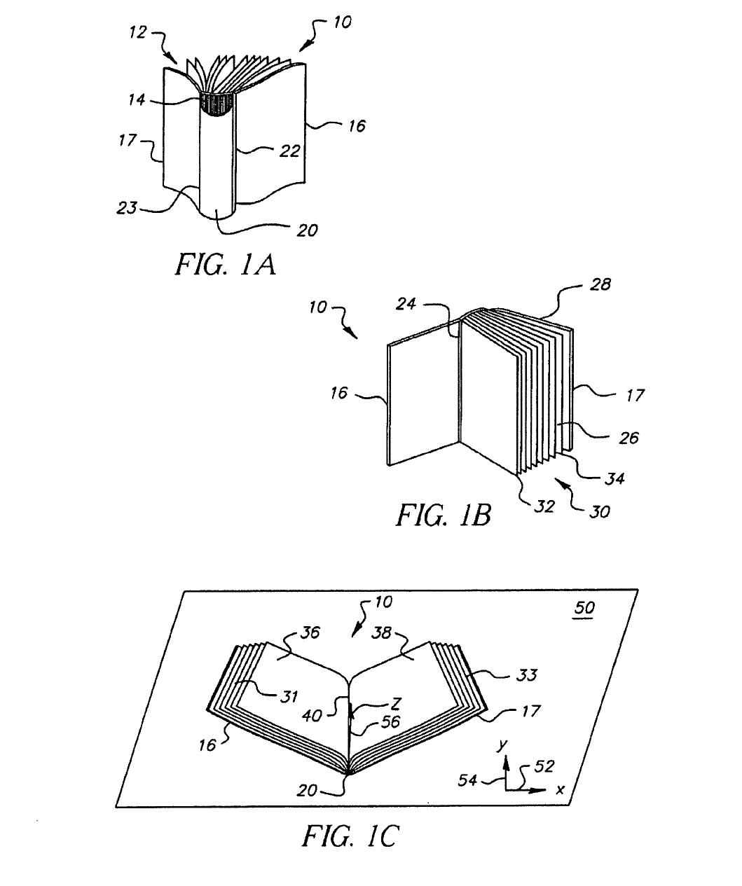

FIG. 1A-1C are perspective views of a book, taken from various angles and with the book in several positions, for purposes of defining terms used in this specification. Referring to FIG. 1A, a typical book 10 comprises a collection of printed sheets or leaves 12, joined at one side thereof by binding 14, which may further comprise sewn thread, staples, adhesives, various combinations thereof, and/or other materials and fastening means known in the art of book binding. Book 10 further comprises a front cover 16 and a back cover 17, joined to spine 20 at joints 22 and 23. As noted above, the disclosed embodiments are further intended to apply to a series of documents that are held in a 3-ring notebook binder, or even an unbound stack of documents, wherein the pages are held, turned and maintained in a seriatim relationship as they are turned, even though there is no spine or similar mechanism for binding the edges of the stack.

Referring to FIG. 1B, the material at joint 22 (of FIG. 1A) is flexible, and forms a hinge 24, which pivotably joins front cover 16 to spine 20. A similar hinge (not shown) joins back cover 17 to spine 20. Covers 16 and 17 may be thin and flexible, commonly a heavy paper stock, wherein covers 16 and 17 are known as wrappers, and book 10 is generally referred to as a paperback book. Alternatively, covers 16 and 17 may comprise a thicker, substantially rigid paperboard material, overlayed with cloth, leather, and the like, wherein book 10 is generally referred to as a hardcover book.

The surface 26 of the leaves 12 of the book 10, which is opposite spine 20, is known as the fore-edge of the book. The surface 28 of the leaves 12 along the top of the book 10 is known as the top edge. In like manner, the surface (not shown) of the leaves 12 along the bottom of the book 10 is known as the bottom edge. The entire collection of bound leaves from the first leaf 32 to the last leaf 34 is known as the text block 30. Accordingly, when referring to a single leaf, the same terms refer to the edges of the particular leaf, which form these respective surfaces. The edge of any leaf that is joined to binding 14 of FIG. 1 is known as a bound edge (not shown).

FIG. 1C is a perspective view of a book resting upon a horizontal surface 50, and supported in an open position, in approximately the position a typical human reader would hold said book while reading it. Referring to FIG. 1C, two pages are exposed for viewing by a human reader, or for image recording by an imaging device. In the library arts, left page 36 is known as the verso page, and right page 38 is known as the recto page. For the purposes of describing the embodiment, the V-shaped intersection 40 between verso page 36 and recto page 38, which is present when book 10 is in an open state, is known as the page bifurcation. In referring to a Cartesian coordinate system in this specification, the x-direction is defined by arrow 52, the y-direction is defined by arrow 54, and the z-direction is defined by arrow 56. The z-direction is along page bifurcation 40, such that the x- and z-axes define the horizontal plane of surface 50, and the y-axis is in the vertical direction, orthogonal to surface 50.

For purposes of describing the embodiment, the height of a book is considered to be the distance from the top edge of a cover to the bottom edge of a cover; the width of a book is considered to be the distance from the spine of the book to the fore edge of a cover; and the thickness of a book is considered to be the distance from the outer surface of the front cover to the outer surface of the back cover, when the book is in a closed state. The height of a leaf (or page) of a book is considered to be the distance from the top edge of the leaf to the bottom edge of the leaf, and the width of a leaf (or page) is considered to be the distance from the bound edge of the leaf to the fore edge of the leaf.

FIG. 1C depicts a book in an open state. For the purposes of this specification, an open state, or open, is meant to indicate that two book pages are visible to a human reader, or are in a position such that images of the pages may be recorded by an imaging device. In practice, a book is therefore in an open state when the angle formed by the intersection of the planes defined by the front and back covers of the book is between approximately 90 degrees and 180 degrees. The term “open pages” refers to the pair of pages, which are readable or imagable when the book is in an open state, i.e. the verso page and the recto page.

As used herein, the act of turning a page forward is defined as the sequence of contacting and grasping or acquiring with fingers, or some apparatus, a leaf comprising a recto page, and pivotally rotating said page about its bound edge, until the surface of said page is in contact with the surface of the former verso page, and the exposed surface of the rotated leaf is the new verso page. Turning a page backwards is the act of displacing a page in a similar manner, but in the opposite direction.

The term pages in sequence is meant to indicate the order in which a human reader or an apparatus would encounter the pages of a book if such person were to commence with the first page of the text block, adjacent to the front cover, and sequentially turn pages until the last page is reached, adjacent to the back cover.

The foregoing description is provided from the standpoint of how most conventional books are read, i.e. seriatim from front cover to back cover, wherein text or other information generally is read from left to right. However, books exist, for which the reader may orient the spine, for example, at the top, and turn the pages from bottom to top, or top to bottom. Furthermore, some languages read in directions other than left to right, which may affect the manner in which a book is read. It may also be desirable to read or acquire images of the pages of a book in other than their ordered sequence. It will therefore be appreciated that minor changes in the software, hardware, and/or sequence of operations would be straightforward in order to assist the reading of such books in a desired manner, and are therefore within the scope of the present disclosure.

As will be noted below, the various embodiments are intended to cover a broad range of possible uses. For example, although described as a page-turning book scanner, the disclosed embodiments may also be employed as an input source for a reading system for blind users, or as a source of image data to be displayed in magnified form for other visually impaired individuals.

Similarly, various aspects of the embodiments may be used independently or in conjunction with other devices. As an example, the page clamping mechanisms of the present invention may be used with bound documentation systems such as catalogs or manuals. One might envision the page clamping mechanism being used in a zero-gravity environment to hold the pages of a book in place so that a user may view the pages while working with both hands.

As another example, aspects of the page turning mechanism described below may be used to advance sheet music pages for a musician or conductor while a musical composition is being performed. Similarly, the device may be used to enable viewing of books by researchers, wherein the books are maintained within a controlled environment and the user simply pushes “page forward” or “page backward” buttons. Having described various potential applications for the system and its various components, attention is now turned to further description of the details of one embodiment.

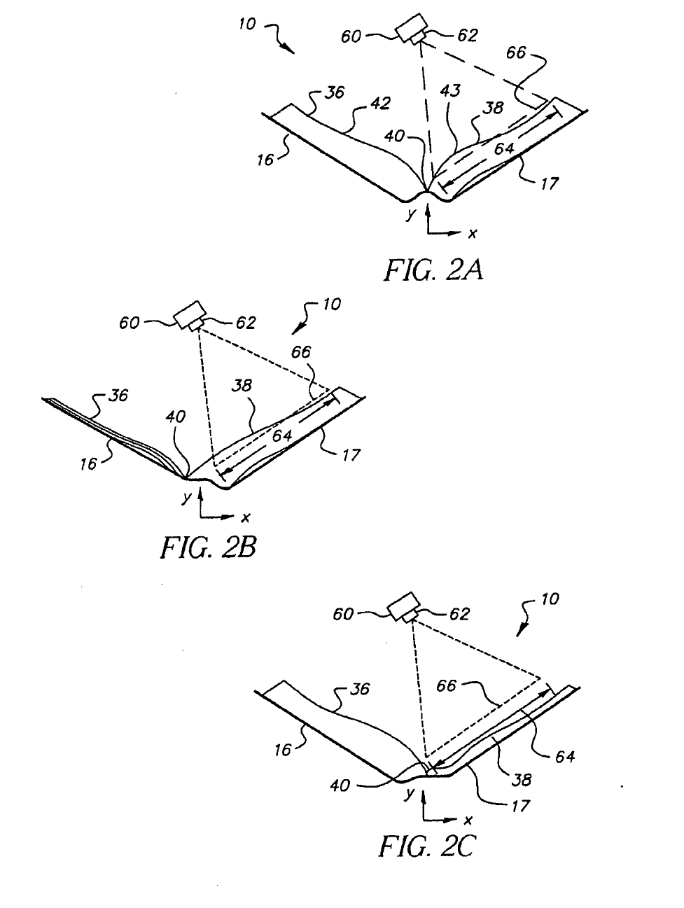

FIGS. 2A-2C are side elevation views of image recording means and of a book, which is open to page locations approximately in the center of the text block, near the front cover of the book and near the back cover of the book, respectively. A comparison of the dimensions of the book and the relationship of the open pages to the image recording means at these three page locations is instructive in comprehending problems which are overcome by the present system.

Referring to FIGS. 2A-2C, an image recording means is provided such as, a camera 60 comprising lens 62. Camera 60 may be a still frame camera, a video camera, a movie camera, a film camera, a digital camera, and the like. In FIGS. 2A-2C, camera 60 is maintained in a fixed position with respect to book 10. In such position, camera 60 has a field of view of width 64, and a height in the z direction (not shown), and a focal plane along dotted line 66, and in the z-direction. It will be apparent that camera 60 as shown in FIGS. 2A-2C is shown only as recording recto page 38, but that this discussion applies in like manner to verso page 36, and that an additional camera, or mirror mechanism may be provided to record images of verso page 36.

In FIG. 2A, camera 60 is positioned such that focal plane 66 and the surface of recto page 38 are proximate to each other, when book 10 is open to approximately the center of the text block. In FIG. 2B, wherein book 10 is open to a page near the front cover 16, and the bulk of the text block lies upon cover 17, recto page 38 is significantly closer to camera 60, and correspondingly displaced above focal plane 66. In like manner, in FIG. 2C, wherein book 10 is open to a page near the back cover 16, and the bulk of the text block lies upon cover 16, recto page 38 is significantly further away from camera 60, and correspondingly displaced below focal plane 66. It is apparent therefore, that a satisfactory apparatus to assist in the automated imaging of a book must make an adjustment in the location of the focal plane 66 of camera 60 as a function of the open page location of book 10, in order to obtain a focused image of each recorded page.

Referring again to FIGS. 2A-2C, one common method of adjusting the focal plane 66 of camera 60 would be through the adjustment of lens 62. However, such an action would be insufficient to enable camera 60 to record an image of the page for several reasons. As pages are turned from a location near the front cover 16 of book 10 (FIG. 2B), to a location near the center of book 10 (FIG. 2A), to a location near the back cover 17 of book 10, while book 10 and covers 16 and 17 in particular are held in a fixed position, the location of page bifurcation 40 also changes substantially in the x-direction. Accordingly, the location of the open pages forming page bifurcation 40 changes with respect to the location of camera 60. A suitable apparatus to assist in image recording of a book must accommodate such a change in location.

It is also apparent that the surfaces of verso page 36 and recto page 38 of FIGS. 2A-2C are also curved, rather than planar. Referring to FIG. 2A in particular, the effect of the binding of folded leaves into groups known as signatures is visible, wherein stresses in signatures 42 and 43 produce significant curvature in verso page 36 and recto page 38. It can be seen, for example, that a portion of recto page 38 near its bound edge is above focal plane 66, and a portion of recto page 38 near its fore-edge is below focal plane 66. Therefore, the recording of a clear, focused image of recto page 38 by camera 60 is not possible without some further provision to render recto page 38 and focal plane 66 congruent.

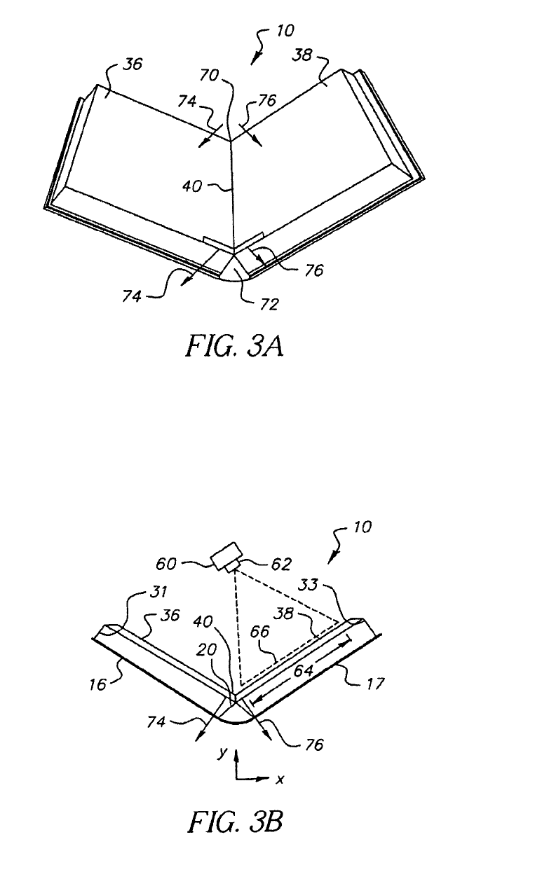

FIG. 3A is a perspective view, which depicts clamps or similar means to flatten the bifurcation and pages of a book so as to produce substantially planar surfaces for each page. Referring to FIG. 3A, upper V-clamp 70 and lower V-clamp 72 are secured to book 10 at page bifurcation 40. V-clamps 70 and 72 apply forces that are substantially normal to pages 36 and 38, as indicated by arrows 74 and 76 respectively. The resulting effect of such forces is depicted in FIG. 3B, wherein recto page 38 is rendered substantially congruent with focal plane 66 of camera 60. Accordingly, a clear, focused image of recto page 38 by camera 60 is made possible.

To summarize, a satisfactory apparatus to assist in the automated imaging of a book must precisely present each page of the book to an imaging system, in order to acquire a clear, complete, and focused image of each page. In order to accomplish this, the apparatus preferably provides means to flatten the open pages of a book, and locate the open pages within the focal plane and field of view of the camera or other image recording means, in order to obtain a clear, complete, and focused image of each page, regardless of the location of the open pages within the book. These features that accommodate variability due to page location within a book are highly advantageous and strongly preferred, in addition to features that accommodate the variability of pages from book-to-book, which were previously described. The apparatus, which accommodates page-to-page and book-to-book variability in a manner superior to prior art apparatus, is now described.

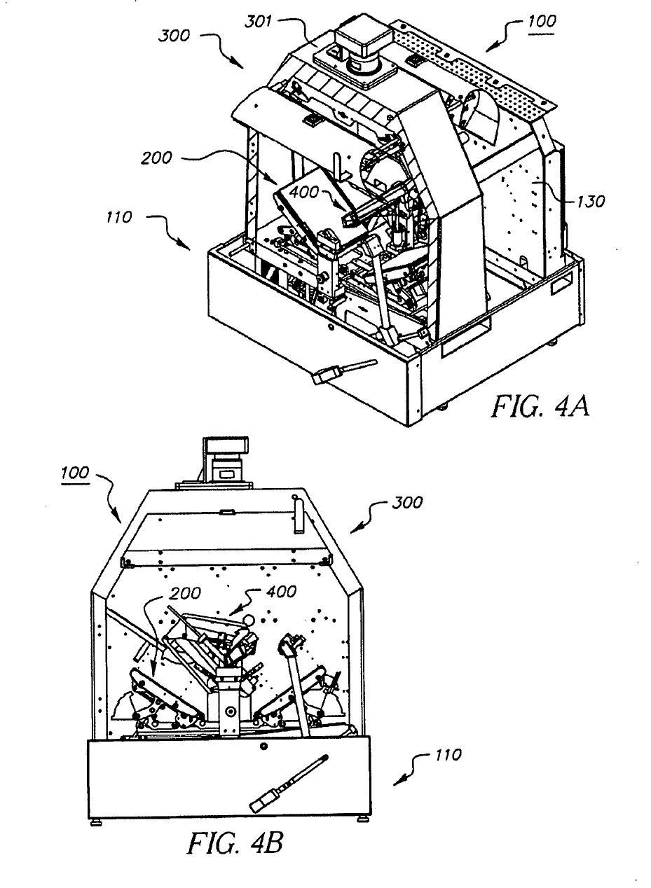

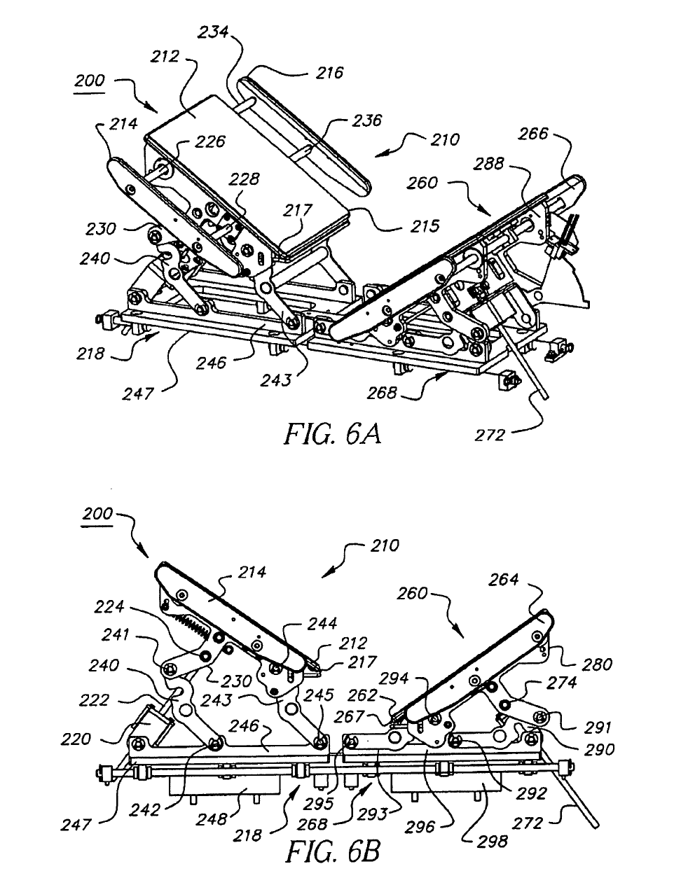

FIGS. 4A and 4B are a perspective view and an elevation view, respectively, of one embodiment of the automated apparatus. Referring to FIGS. 4A and 4B, apparatus 100 comprises several assemblies, which operate together to perform the process of automated image acquisition of the pages of a book. Base 110 and back plate 130 support and/or house the mechanical and imaging components of apparatus 100. Cradle assembly 200 holds a book (not shown) in position, and presents the open pages of the book for image acquisition. Optical assembly 300 comprises a camera, mirrors, lighting, and page position sensors for obtaining a clear, complete, and focused image of each page of the book. Page turning assembly 400 comprises a fluffer for raising and isolating a leaf to be turned, and a page turning arm and head for acquiring the leaf and turning it such that a subsequent pair of open pages are made available for the image acquisition cycle. Each of these assemblies are further described in detail in this specification, and in FIGS. 6A through 17.

Cradle Assembly

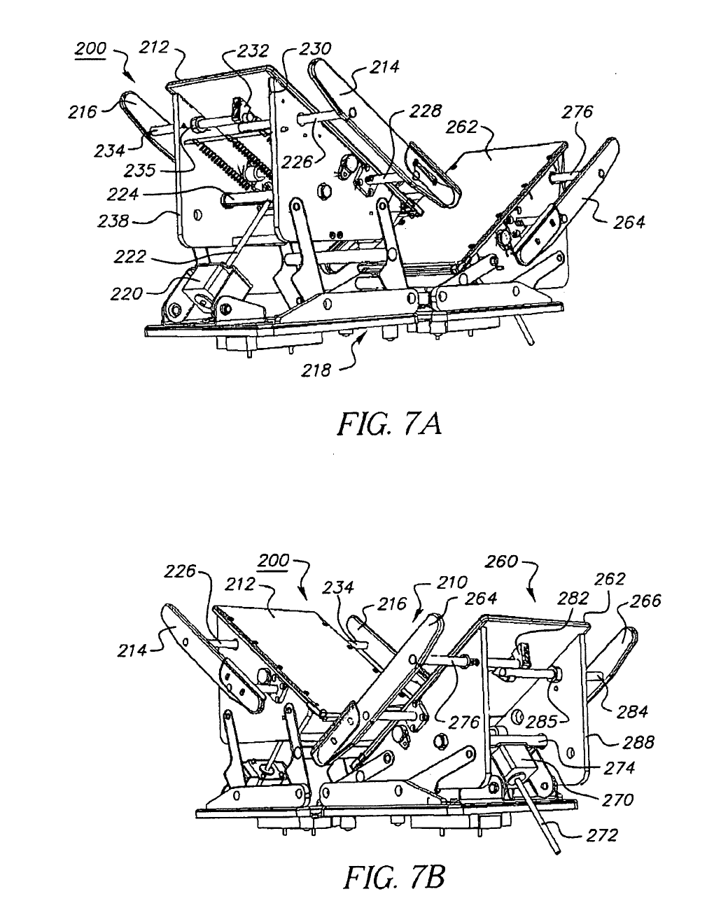

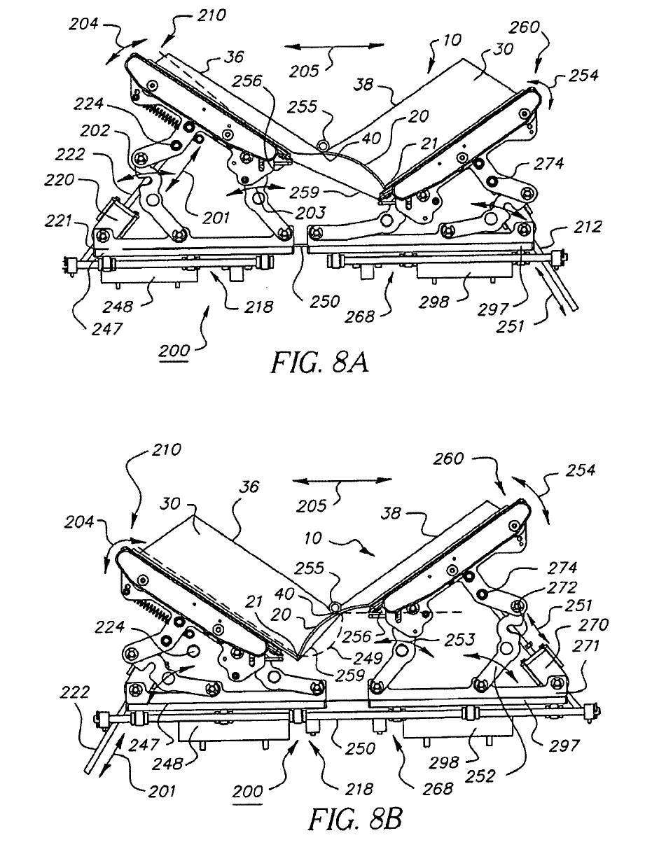

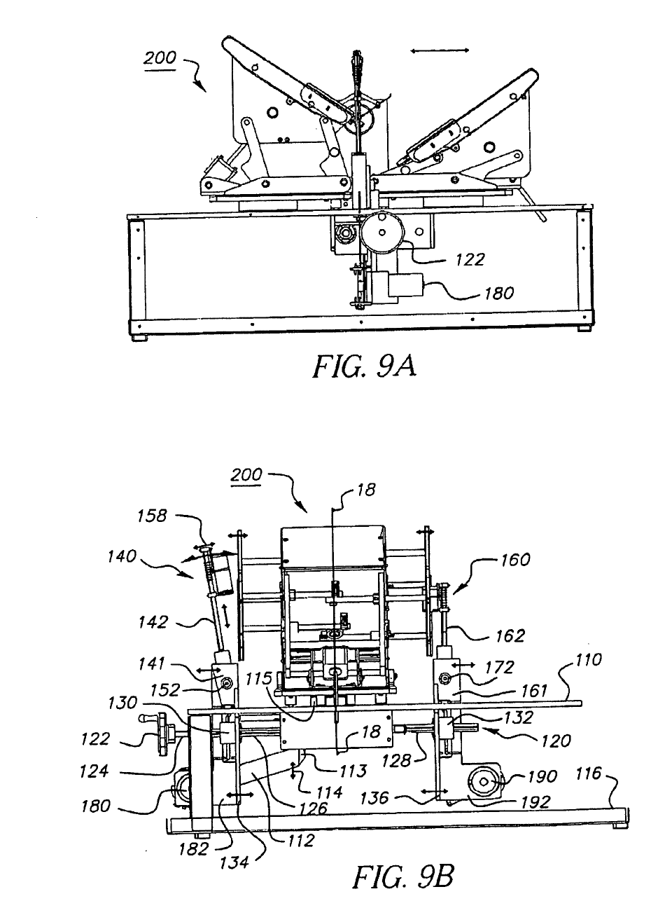

The components and function of cradle assembly 200 is presently described in detail by reference to the drawings as follows: FIGS. 6A and 6B are a perspective view and an elevation view, respectively, of a cradle assembly of the apparatus. FIGS. 7A and 7B are additional elevation views from the left front and right front, respectively, of a cradle assembly of the apparatus. FIG. 8A is an elevation view of the cradle assembly, further depicting a book held by the cradle assembly, shortly after the beginning of the page imaging process. FIG. 8B is an elevation view of the cradle assembly, further depicting a book held by the cradle assembly, shortly before the end of the page imaging process. FIG. 9A is a front elevation view of the cradle assembly and clamp and cradle adjustment mechanisms housed in the base of the apparatus. FIG. 9B is a side elevation view of the cradle assembly and clamp and cradle adjustment mechanisms of FIG. 9A.

Referring to FIGS. 6A, 6B, 7A, and 7B, cradle assembly 200 comprises a left cradle half 210 and a right cradle half 260. Left cradle half 210 further comprises book support plate 212, book cover clamps 214 and 216, linkage 218, drive motor 220, drive shaft 222, and lift rod 224. In like manner, right cradle half 260 further comprises book support plate 262, book cover clamps 264 and 266, linkage 268, drive motor 270, drive shaft 272, and lift rod 274.

Book cover clamp 214 is joined to rods 226 and 228, which are slidably mounted through front upright plate 230, and through upper block guide 232 and lower block guide (not shown), respectively. Book cover clamp 216 is joined to rods 234 and 236, which are slidably mounted through rear upright plate 238, and through upper block guide 232 and lower block guide (not shown), respectively. Book cover clamp 216 is retained within cradle assembly 200 by the use of shaft collar 235, which is attached to rod 234. In like manner, book cover clamp 214 is retained within cradle assembly 200 by the use of a similar shaft collar (not shown), which is attached to rod 226.

In like manner, on right cradle half 260, book cover clamp 264 is joined to rods 276 and 278, which are slidably mounted through front upright plate 280, and through upper block guide 282 and lower block guide (not shown), respectively. Book cover clamp 266 is joined to rods 284 and 286, which are slidably mounted through rear upright plate 288, and through upper block guide 282 and lower block guide (not shown), respectively. Book cover clamp 266 is retained within cradle assembly 200 by the use of shaft collar 285, which is attached to rod 284. In like manner, book cover clamp 264 is retained within cradle assembly 200 by the use of a similar shaft collar (not shown), which is attached to rod 276.

On the front side of left cradle half 210, linkage 218 comprises links 240 and 243, which are pivotably joined to front upright plate 230 by pins 241 and 244, respectively. Links 240 and 243 are also pivotably joined to lower plate 246 by pins 242 and 245, respectively. Lower plate 246 is joined to left cradle base 247. Linkage 218 is further comprised of a set of substantially the same components (not shown) on the rear side of left cradle half 210.

In like manner, on the front side of right cradle half 260, linkage 268 comprises links 290 and 293, which are pivotably joined to front upright plate 280 by pins 291 and 294, respectively. Links 290 and 293 are also pivotably joined to lower plate 296 by pins 292 and 295, respectively. Lower plate 296 is joined to right cradle base 297. Linkage 268 is further comprised of a set of substantially the same components (not shown) on the rear side of right cradle half 260.

The aforementioned components of cradle assembly 200 enable it to be adjusted to suitably image the pages of books of a wide range of page sizes and thicknesses, and to properly present each pair of open pages of a book for image acquisition, wherein the open pages are properly located within the focal plane and field of view of the camera in order to acquire a clear, complete, and focused image of each page. The operation of cradle assembly 200 to accomplish such task is now described.

FIG. 8A is an elevation view of the cradle assembly, further depicting a book held by the cradle assembly, shortly after the beginning of the page imaging process; and FIG. 8B is an elevation view of the cradle assembly, further depicting a book held by the cradle assembly, shortly before the end of the page imaging process. Referring to FIGS. 8A and 8B, book 10 is held in cradle assembly 200. At the beginning of the book imaging process, and prior to the imaging of any pair of open pages, the position of verso page 36 is adjusted by the operation of cradle half 210, and the position of recto page 38 is adjusted by the operation of cradle half 260.

To adjust the position of verso page 36 a positioning means is employed, for example, drive motor 220, which is pivotably joined to left cradle base 247 by bracket 221, is operated. Drive motor 220 moves drive shaft 222 along its axis in the directions indicated by arrow 201. Lift rod 224, being joined to drive shaft 222, is displaced accordingly, and further produces the action of linkage 218, indicated by arcuate arrows 202 and 203. Thus, the position of left cradle half 210 and verso page 36 of book 10, indicated by arcuate arrow 204, is adjusted by operation of drive motor 220.

In like manner, to adjust the position of recto page 38 a positioning means is employed, for example, drive motor 270, which is pivotably joined to left cradle base 297 by bracket 271, is operated. Drive motor 270 moves drive shaft 272 along its axis in the directions indicated by arrow 251. Lift rod 274, being joined to drive shaft 272, is displaced accordingly, and further produces the action of linkage 268, indicated by arcuate arrows 252 and 253. Thus, the position of right cradle half 260 and verso page 38 of book 10, indicated by arcuate arrow 254, is adjusted by operation of drive motor 270.

The horizontal position of book 10 is further adjustable in the x-direction, indicated by arrow 205. Left cradle half 210 and right cradle half 260 are joined by cradle hitch 250, and are slidably mounted on left slide mechanism 248 and right slide mechanism 298, which in turn are joined to a base 110. (See FIG. 9A.) To effect the motion indicated by arrow 205, the assembly comprising left cradle half 210, right cradle half 260, and link 250 are operatively coupled to a drive motor (not shown) or similar positioning means, which adjusts the position of the cradle halves in the x-direction. In an alternative embodiment, the cradle is moved in response to the motion of a clamping mechanism or similar device that may be connected to the cradle. In particular a cam-type locking mechanism may be employed such that the cradle, or at least halves thereof, are free to move when a clamping mechanism is engaged with the book—thereby enabling the self-centering or adjustment of the cradle halves in response to the clamp force. And, the cradle halves are locked in horizontal position when the clamps are removed, in order to hold the book in a centered position for page turning. In an alternate embodiment (not shown), cradle hitch 250 is not present, and each of cradle halves 210 and 260 are operatively coupled to separate drive motors. In this embodiment, the positions of cradle halves 210 and 260 are independently adjustable in the x-direction. This feature provides additional capability of the apparatus 100 to accommodate books of varying sizes and properties. In particular, it renders the apparatus 100 more capable of accommodating book-to-book variation in spinal configuration when such books are placed in cradle assembly 200. Such book-to-book spinal variation results in variation of the foreshortening of book pages as the apparatus turns pages and proceeds through the text block of the book. Thus, the apparatus can both properly image books that have significantly arched spines and books that have substantially flat spines.

A better understanding of the foreshortening of book pages is attained by reference to FIG. 1C and FIG. 3B. Referring to FIG. 3B, book 10 depicted therein comprises a spine 20, which is highly arched and substantially hinge-like proximate to page bifurcation 40. The resulting effect of such a hinge-like spine is that the edge 31 of the left text block is slightly angled, but nearly perpendicular to front cover 16, and the edge 33 of the right text block is slightly angled, but nearly perpendicular to back cover 17. Book 10 of FIG. 3B is thus considered to have a small amount of page foreshortening.

In contrast, refer now to FIG. 1C. Book 10 depicted therein also comprises a spine 20, which instead is substantially planar. The resulting effect of such a planar spine is that the edge 31 of the left text block is highly angled with respect to front cover 16, and the edge 33 of the right text block is highly angled with respect to back cover 17. Book 10 of FIG. 3B is thus considered to have a large amount of page foreshortening. It will be apparent that there is a need to detect the extent of page foreshortening during the imaging of a book, and adjust the imaging system as required in order to obtain complete images of each of the pages of such book. The manner in which the apparatus addresses such a need is presented below.

Referring again to FIGS. 8A and 8B, respectively depicting a book held shortly after beginning page imaging and shortly before the end of page imaging, after the book is loaded in the cradle at the beginning of the book imaging process, the position of the first pair of open pages is adjusted by the operation of drive motors 220 and 270 so that the pair of open pages is properly located within the focal plane and field of view of the camera. The page imaging and page turning cycles (to be described subsequently) then proceed.

Early in the overall process, the thickness of the portion of text block beneath verso page 36 is small, and the thickness of the portion of text block beneath recto page 38 is large, as shown in FIG. 8A. As these page imaging and page turning cycles continue, the thickness of the portion of text block beneath verso page 36 increases, and the thickness of the portion of text block beneath recto page 38 decreases to a condition late in the process, shown in FIG. 8B. To properly locate the pair of open pages within the focal plane and field of view of the camera, the individual positions of left cradle half 210 and right cradle half 260 are adjusted as previously described, and as shown in FIGS. 8A and 8B. The x-positions of cradle halves 210 and 260 are also adjusted as described. Thus, throughout the page imaging process, the positions of verso page 36 and recto page 38 are adjusted in order to obtain a clear, complete, and focused image of each page.

In one embodiment, optical sensing means are provided, to detect the position of the page bifurcation in order to more precisely control the positions of the verso and recto pages. Referring to FIGS. 8A and 8B, optical sensing means 255 is installed in substantially the position in which it is desired to maintain page bifurcation 40 during the page imaging process, in order to optimize the positions of verso page 36 and recto page 38. Thus, as the page imaging process proceeds, and the text block of book 10 undergoes a transition from FIG. 8A to FIG. 8B, optical sensing means 255 continuously detects the position of page bifurcation 40. The data from optical sensing means 255 is used by the apparatus controller (not shown) to adjust the drive motor, or motors (not shown), which control the x-positions of cradle halves 210 and 260. Accordingly, the positions of verso page 36 and recto page 38 are maintained in order to obtain a clear, complete, and focused image of each page.

In general, optical sensing means 255 “sees” in a direction substantially along the z-axis and parallel to page bifurcation 40. A variety of devices well known in the art are suitable as optical sensing means 255. In one embodiment, optical sensing means 255 comprises a photodiode on one side of the book, and a photodetector on the other side of the book. In a similar embodiment, optical sensing means 255 comprises an integrated photodiode and detector on one side of the book, and a reflector on the other side of the book. In each of these embodiments, the position of page bifurcation 40 is detected by the passage of a beam of light substantially congruent with page bifurcation 40; or, if page bifurcation is not in the desired position, the obstruction of the beam of light. In other words, sensor 255 may be used to not only determine the bifurcation location, but also as a page-clear sensor, indicating that a page has not been fully turned or has otherwise not “cleared” an open area adjacent the spine.

In an alternate embodiment, optical sensing means 255 comprises a camera, and image acquisition or machine vision hardware and software, such that the image of page bifurcation is recognized. In particular, the V-shaped discontinuity of page bifurcation 40 is recognized, and the image processing data, which digitally represents the shape and position of page bifurcation 40 is used by the apparatus controller (not shown) to adjust the drive motor, or motors (not shown), which control the x positions of cradle halves 210 and 260.

In general, optical sensing means 255 may comprise any combination of hardware, software, and computer controls, which are capable of sensing the V-shaped discontinuity of page bifurcation 40. As noted above, the cradle halves may be operatively connected by link 205, and may be adjusted in the direction indicated by arrow 205 (FIGS. 8A and 8B for example). In this manner, the cradle assembly may be moved, possibly under control of the controller (computer controls), to permit the centering or alignment of a document held in the cradle assembly. Although referred to as centering, it will be appreciated that the document may not be centered so much as aligned in a manner to permit desired viewing or imaging of the document by the optical system employed.

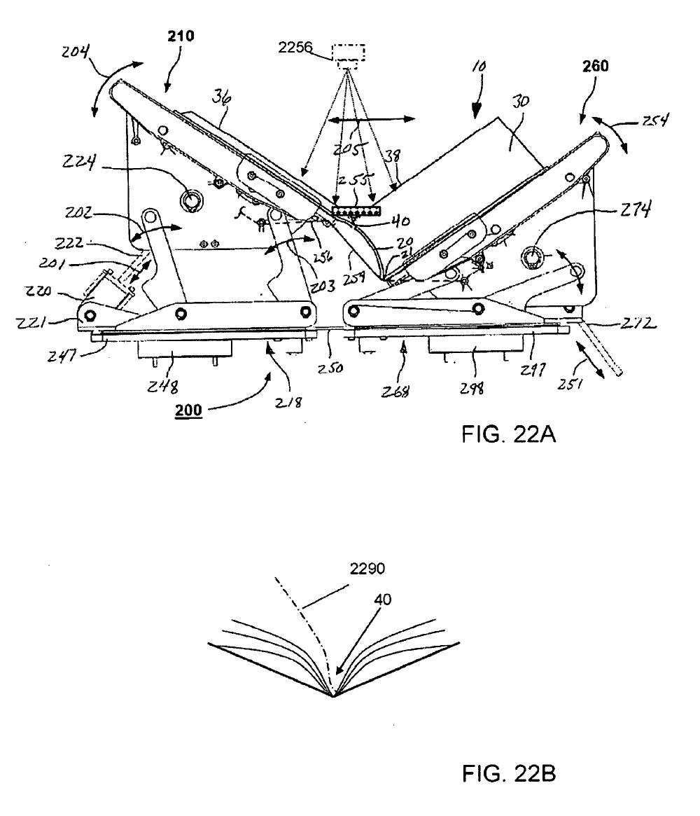

As noted above, a variety of devices are suitable as optical sensing means 255 as depicted in FIG. 8A. In each of these embodiments, the position of the page bifurcation 40 is detected by the passage of a beam of energy (e.g., visible light) substantially congruent with page bifurcation 40, or if the page bifurcation is not in the desired position, the obstruction of the beam of light. In yet a further alternative, referring also to FIGS. 22A-B and 23D-E, a variable bifurcation sensing system and/or a feedback system, may be provided by employing a photodiode array 255 (linear or two-dimensional) for the optical sensing means. In such an embodiment, the photodiode array 255 would be arranged in the manner discussed above near a spine of the document (on opposite sides, or on same side with a mirror or reflector 2255 on the opposite side), to sense the page bifurcation location. Such detection is also carried out using the controller as part of the adjustment step 524 as described herein.

One method of identifying the bifurcation position using the array of photodiodes is to find which of the photosensors placed along the document spine has a peak level when compared to other, adjacent photosensors—the peak level indicating the photosensor that has the least obstruction by the document pages. It will be further appreciated that location averaging or other mathematical techniques may be employed to analyze the output of the photosensors of photodiode array 255 in order to determine the page bifurcation (e.g., determining the location as the average position of all of a series of photosensors above a threshold level). The array of photosensors may also be useful in providing the controller with feedback or data for control of the bifurcation position, such that when the cradle assembly is moved in the direction of arrow 205 (e.g., FIG. 22A) using cradle drive motors (not shown), the system may identify whether it is being moved in an appropriate direction, as well as when movement has resulted in the document being “centered.” Notably, movement in the direction of arrow 205 may be accomplished manually or using the controller connected to a drive motor of similar means for adjusting the position of the cradle assembly.

In yet another alternative, the system may employ a real-time imaging device such as a digital camera or a charge-coupled device (CCD), again located on a side of the document and along the spine in the position of the array 255, to acquire images of the spine region, including the bifurcation area, and to thereby identify the bifurcation location and adjust the cradle accordingly.

As depicted in FIG. 22B, the image of an end of the book may also be employed to detect the presence of an unturned or disturbed page 2290. The presence of such a page may require further operations, or manual intervention, and it is considered an advantage to avoid damage to such a page by the use of clamping or flattening mechanisms designed to work on completely turned pages. In order to image the bifurcation region, lighting may be applied from the camera side or possibly from the opposite side of the book. Moreover, such lighting may be infrared and the camera or CCD infrared sensitive to avoid errors due to the ambient light. Furthermore, the use of a camera may also permit the spine to be imaged at the same time, thereby being able to determine a proper adjustment of the cradle assembly to accommodate different types of spines, spine positions, etc. In summary, the camera or CCD could permit the detection of the bifurcation location, determine the profile (involute) of the spine, identify when a page has not been complete turned, and determine the spine foreshortening of the pages.

In a further alternative, the use a distance measuring device 2256 (laser light, sound, etc.) may be employed from a position above the opened document, to detect the maximum distance to the page surfaces for the opposed pages, and at the bifurcation position (bottom of the “V”), the distance will be maximized. And in yet another alternative, camera 60 may itself be employed to image the pages and the bifurcation region, and then the use of image processing techniques may be employed to determine, or accurately estimate the location of the bifurcation. Such a system may operate by collectively analyzing the pixel data along a line (or multiple lines) traversing the bifurcation area, and then using pattern-matching to identify the left page margin, the bifurcation region, and the right page margin. From such information, it may then be possible to identify the exact location of the bifurcation as the “darkest” position along such a line, or as an average between the two opposed margins, etc.

In a further embodiment, after the horizontal position of the cradle assembly and book supported therein is adjusted as desired, by the use of cradle drive motors, and/or page bifurcation sensing means, and/or page clamp assemblies (to be described subsequently in this specification), the horizontal position of the cradle assembly and book is fixed by engagement of a slide detent. Referring to FIG. 9B, slide trip plate 112 is operatively engaged with motor 180, such that the operation of motor 180 in forward and reverse directions effects the upward and downward movement of the end 113 of slide trip plate 112, as indicated by arrow 114.

The upper extremity (not shown) of the end 113 of slide trip plate 112 is operatively engaged with slide detent 115, such that the upward and downward motion of the end 113 of slide trip plate 112 produces a corresponding upward and downward motion of slide detent 115. In one embodiment (not shown), slide detent comprises an L-shaped piece having a horizontal surface as one leg of the L. When slide detent 115 is raised upwardly, this horizontal surface contacts a corresponding surface of base 297 of right cradle half 260 and/or base 247 of left cradle half 210 (See FIG. 8A).

Thus, when motor 180 operates to produce an upward motion of slide detent 115, slide detent 115 is engaged with and prevents motion of cradle assembly 200 and the book supported therein. It is noted that the operation of motor 180 is used for the dual purposes of engaging slide detent with cradle assembly 200, and deploying page clamp assembly 140 upon the book, to be subsequently described in this specification.

In a further embodiment, a book is supported within the cradle assembly by the use of a spine cloth or web, which is suspended between the lower portions of each cradle half. During the imaging of a book, the spine cloth is in supportive contact with the spine of the book, such that the possibility of the book falling between the two cradle halves is eliminated.

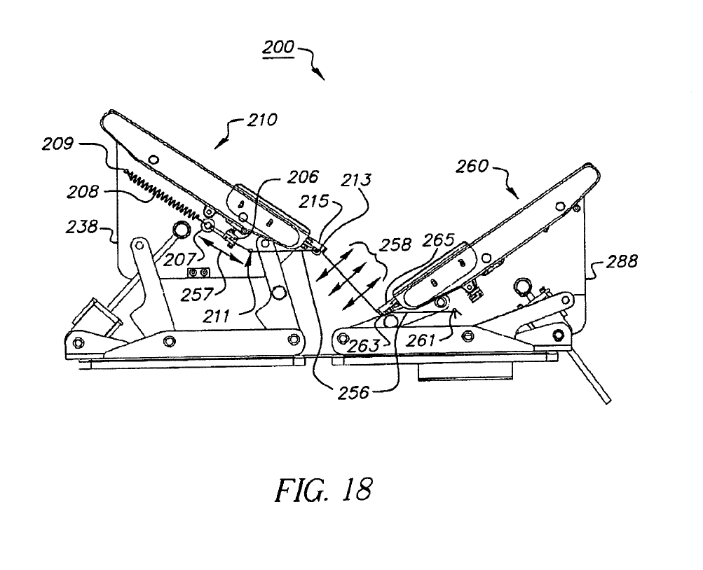

FIG. 18 is a sectional view of a cradle assembly of the apparatus, taken at line 18-18 of FIG. 9B. Referring to FIG. 18, spine cloth 256 is operatively joined at a first end to cylindrical shaped bar 261, which is supported at its back end by rear support plate 238, and at its front end by front support plate 230 (see FIGS. 6A and 6B). Spine cloth 256 is also joined at its second end to clamp 206.

Spine cloth 256 is further supported and routed through cradle halves 210 and 260 by additional members. Spine cloth 256 is routed over roll 263, across the space between cradle half 210 and cradle half 260, over roll 213, and beneath roll 211. Cylindrical shaped bar 211 is supported at its back end by rear support plate 238, and at its front end by front support plate 230 (see FIGS. 6A and 6B). Roll 213 is also cylindrical shaped, and supported at its back end by bracket 215, and at its front end by bracket 217 (see FIGS. 6A and 6B). In like manner, roll 263 is supported at its back end by bracket 265, and at its front end by bracket 267 (see FIG. 6B).

To provide a supporting force upon a book spine, tensioning means are provided, which pull spine cloth 256 taut against at least a portion of the spine of the book being imaged. Referring again to FIG. 18, and in one embodiment, tensioning means comprises a spring 208 connected at a first end to cylindrical bar 209, and at its opposite end to eyebolt 207, which is operatively connected to clamp 206. Cylindrical bar 209 is similarly supported by support plates 230 and 238, as recited previously for cylindrical bar 211. Spring 208 is preferably a wound wire or coil spring, and spring 208 is chosen to have dimensions and a force constant such that spine cloth 256 is placed in tension by the action of spring 208.

Thus, in the absence of a book being held in cradle assembly 200, spine cloth 256 forms a substantially planar surface in the span 259 between rolls 213 and 263 of cradle halves 210 and 260, respectively. However, when a book is present, spine cloth 256 is free to deform in the general direction indicated by arrows 258. Span 259 between rolls 213 and 263 lengthens accordingly, with the corresponding length change accommodated by the stretching of spring 208, as indicated by arrow 257. The tension of spine cloth 256 applies a force upon the book spine in substantially the opposite direction of that indicated by arrows 258.

FIGS. 8A and 8B depict the contact of spine cloth 256 with the spine 20 of book 10. In the embodiment depicted in FIGS. 8A and 8B, book 10 comprises a concave or arched spine, and only a small portion 21 of spine 20 is in contact with the span 259 of spine cloth 256. FIG. 8B further depicts the instance where book 10 comprises a convex spine 249, shown in dotted outline form. It will be apparent that in such an instance, span 259 would become congruent with convex spine 249, as a result of the tension upon spine cloth 256. It is noted that FIGS. 8A and 8B further illustrate that because spine cloth 256 comprises a flexible material, it maintains contact with book spine 20 of book 10, as the imaging process proceeds seriatim through the text block 30 of book 10.

It is to be understood that although in this specification the flexible web of material is described as spine cloth 256, there is no intent to limit the material selection of such web material to cloth. Such web may be formed from a variety of flexible sheet goods, such as leather, thin polymer film, polymer netting, sheet rubber, materials with such coating thereon and the like, with the operative requirement being that when the flexible web is put in tension, it conforms to and provides a supporting force upon at least a portion of book spine 20, such that book 10 is further supported in cradle assembly 200.

Page Clamps

Prior to acquisition of images for each pair of open pages, such pages may be further precisely positioned for imaging by forcing them to take the shape of substantially planar surfaces. As was previously described, and depicted in FIGS. 3A and 3B, the use of clamps at the page bifurcation provides a suitable means of flattening the open pages into substantially planar surfaces. In one embodiment, such clamps are provided. Such clamps are believed to preferably be automatically deployed during each page imaging cycle, but retracted when the pages are being turned so as not to interfere with the pages or page turning mechanisms.

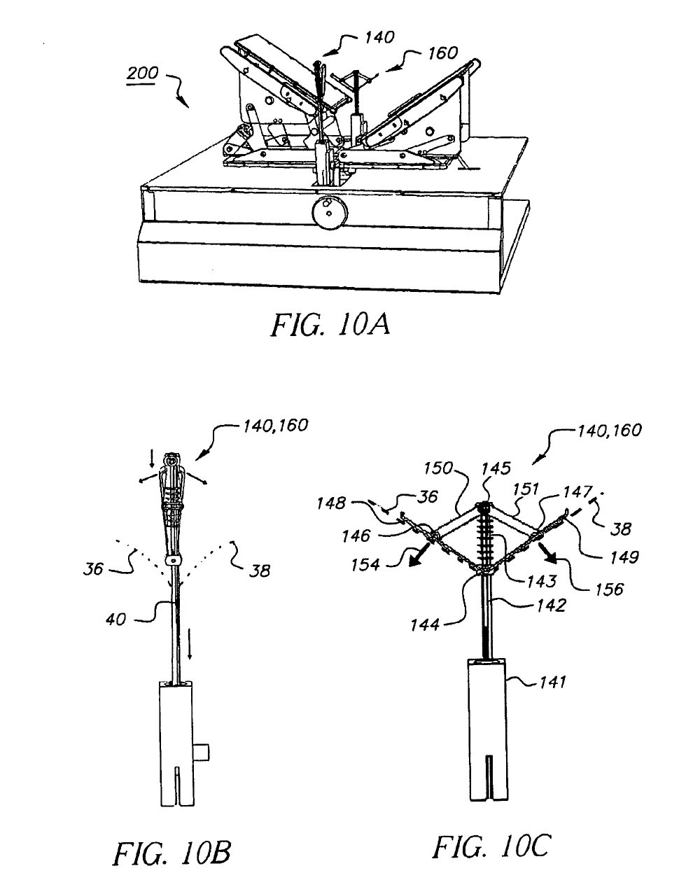

FIG. 10A is a perspective view of the cradle assembly, further depicting page clamps for flattening the open pages prior to page imaging. Referring to FIG. 10A, the apparatus is provided with a front clamp assembly 140 and a rear clamp assembly 160. It is to be noted that for illustrative purposes in FIG. 10A, front clamp assembly 140 is shown in a retracted state, and rear clamp 160 assembly is shown in a deployed state. However, in operation of the apparatus, clamp assemblies 140 and 160 are typically deployed together to flatten the pages of a book, and released together to release the pages of a book.

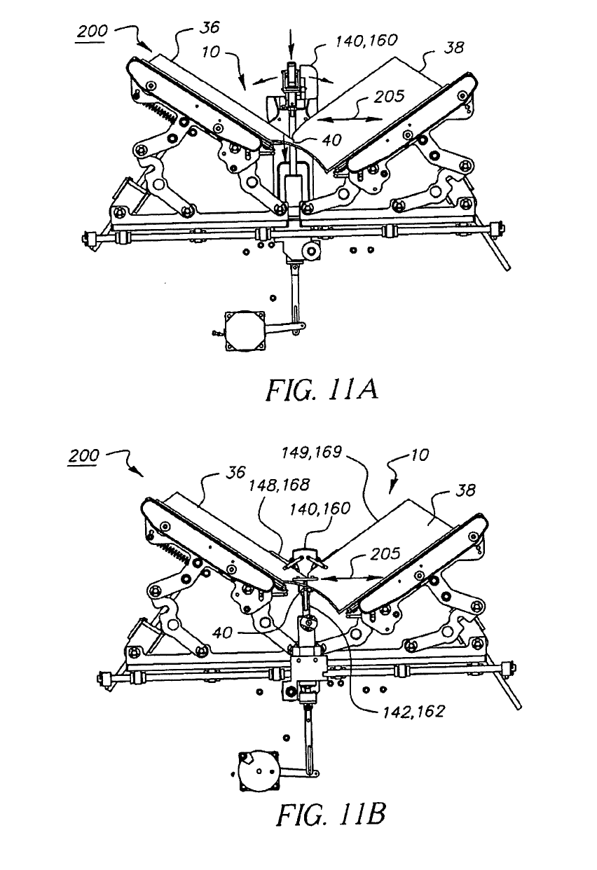

FIGS. 10B and 10C are elevation views of a page clamp in the released position, and the deployed position, respectively. Referring to FIG. 10C, page clamp assembly 140/160 comprises pivot block 141, pull rod 142, spring 143, pins 144 and 145, pivot lugs 146 and 147, spreaders 148 and 149, and links 150 and 151. In operation, the retracted clamp assembly 140/160 of FIG. 10B is pulled downwardly by pull rod 142 towards page bifurcation 40, located between verso page 36 and recto page 38 (shown as dotted lines). Because links 150 and 151 are pivotally joined to pull rod 142 by pin 145, and to spreaders 148 and 149 by pivot lugs 146 and 147 respectively, and spreaders 148 and 149 are pivotably and slidably joined to pull rod 142, the downward movement of clamp assembly 140/160 deploys spreader 148 against verso page 36 and spreader 149 against recto page 38. Spring 143 provides through the linked mechanism a substantially normal force of spreaders 148 and 149 against verso page 36 and recto page 38, indicated by arrows 154 and 156 respectively. As a result of such forces, page bifurcation 40 is spread open, and verso page 36 and recto page 38 are flattened into substantially planar surfaces, and thereby made ready for image acquisition. For further illustration, FIG. 11A depicts a book held by the cradle assembly, with page clamp assemblies 140/160 in the released position; and FIG. 11B depicts a book held by the cradle assembly with page clamp assemblies in the deployed position.

At the beginning of the book imaging process, the position of page clamp assemblies 140 and 160 are adjusted to place them in proper position relative to the height of the book. FIG. 9B is a side elevation view, which depicts means for making such an adjustment of page clamp assemblies 140 and 160. Referring to FIG. 9B, cradle assembly 200, which holds a book (not shown), is mounted upon base 110. Lead screw mechanism 120 is mounted to base 110, upon the underside thereof, and above floor pan 116. Lead screw mechanism 120 comprises an adjustment knob 122, and a shaft 124 having a first portion 126 comprising left hand threads, and a second portion 128 comprising right hand threads. Shaft 124 is threadedly engaged with left hand lead screw nut 130, which is suitably joined to front support plate 134. Shaft 124 is also threadedly engaged with right hand lead screw nut 132, which is suitably joined to rear support plate 136. Front clamp assembly 140 is pivotably joined to front support plate 134 at pivot block 141, and rear clamp assembly 160 is pivotably joined to rear support plate 136 at pivot block 161. Accordingly, when adjustment knob 122 is turned clockwise, front clamp assembly 140 and rear clamp assembly 160 are moved away from each other, and when adjustment knob 122 is turned counterclockwise (See FIG. 9A), front clamp assembly 140 and rear clamp assembly 160 are moved toward from each other. Thus, at the beginning of a book imaging process, clamp assemblies 140 and 160 are separated from each other sufficiently to allow the book to be loaded onto cradle assembly 200. Subsequently, adjustment knob 122 is turned to bring clamp assemblies proximate to the book, so that they will engage and flatten the pages in order to obtain satisfactory page images as previously described.

During each imaging cycle, i.e. the acquisition of images of verso and recto pages, clamp assemblies 140 and 160 are deployed as previously described herein. During each page turning cycle, clamp assemblies 140 and 160 are retracted, so that the next leaf is free to be turned. Clamp assemblies move upwardly during retraction, as indicated by the transition from FIG. 10 C to FIG. 10B. However, in order to provide sufficient clearance for a page to be turned, the step of clamp assembly retraction preferably comprises vertical retraction upwardly from the page bifurcation, and horizontal retraction outwardly relative to the top and bottom edges of the book. The apparatus provides clamp assemblies with such capability, which is now described.

Referring again to FIG. 9B, it is first noted that for illustrative purposes, clamp assembly 140 is shown in the retracted position, and clamp assembly 160 is shown in the deployed position. However in the operation of the apparatus, clamp assemblies 140 and 160 are deployed together in the position of clamp assembly 160 during the imaging cycle, and clamp assemblies 140 and 160 are retracted together in the position of clamp assembly 140 during the page turning cycle. It can be seen that clamp assembly 140, in the retracted position, has been horizontally retracted outwardly by a pivoting motion indicated by arcuate arrow 158 around pivot bolt 152. In like manner, clamp assembly 160 is horizontally retracted to an analogous location when in its retracted position.

To accomplish deployment and retraction, clamp assembly 140 is driven by drive motor 180. Drive motor 180 is suitably mounted upon cam front support plate 182. The shaft (not shown) of drive motor 180 is suitably operatively connected to a clamp drive lug (not shown), which comprises a lever arm. Said clamp drive lug is further connected to a clamp spring link (not shown), which in turn is connected to pull rod 142. When drive motor 180 is rotated clockwise (with respect to the view of FIG. 9B), said clamp spring link produces a downward motion of pull rod 142, and a rotational motion of pivot block 141 around the axis of pivot bolt 152. Accordingly, clamp assembly 140 is moved to the deployed position previously described and shown by clamp assembly 160 of FIG. 9B. When drive motor 180 is rotated counterclockwise (with respect to the view of FIG. 9B), said clamp spring link produces a upward motion of pull rod 142, and a rotational motion of pivot block 141 around the axis of pivot bolt 152. Accordingly, clamp assembly 140 is moved to the retraced position previously described and shown by clamp assembly 140 of FIG. 9B. The deployment and retraction of clamp assembly 160 is accomplished by drive motor 190 in substantially the same manner, with a mechanism that is the mirror image of that described herein for clamp assembly 140.

In one embodiment, the action of deploying the clamp assembly to secure and flatten the open pages of the book is also used to locate the book in the desired position in the x-direction beneath the optical assembly, so that the desired page images are recorded. Referring to FIGS. 11A and 11B, when the deployment of page clamp assemblies 140 and 160 occurs, page clamp assemblies 140 and 160 are driven downwardly into page bifurcation 40 of book 10. Spreaders 148 and 149 of clamp assembly 140, and spreaders 168 and 169 of clamp assembly 160 engage verso page 36 and recto page 38 of book 10. Book 10, being supported upon slidably mounted cradle assembly 200 as indicated by arrow 205, will be forced to move in the x-direction such that the page bifurcation is in alignment with clamp pull rods 142 and 162 of clamps 140 and 160, respectively. In this manner, book 10 is always located during the imaging process such that page bifurcation 40, verso page 36, and recto page 38 are in a fixed position with respect to optical assembly 300 (see FIG. 4B). Accordingly, the desired images of verso page 36 and recto page 38 are consistently obtained as the apparatus acquires the page images seriatim.

It is noted that in the operations recited above, the operation of motor 180, which deploys page clamp assembly 140, also serves the function of engaging slide detent 115 with cradle assembly 200 in order to prevent further horizontal motion of cradle assembly 200 during the imaging process, as described previously in this specification and shown in FIG. 9B.

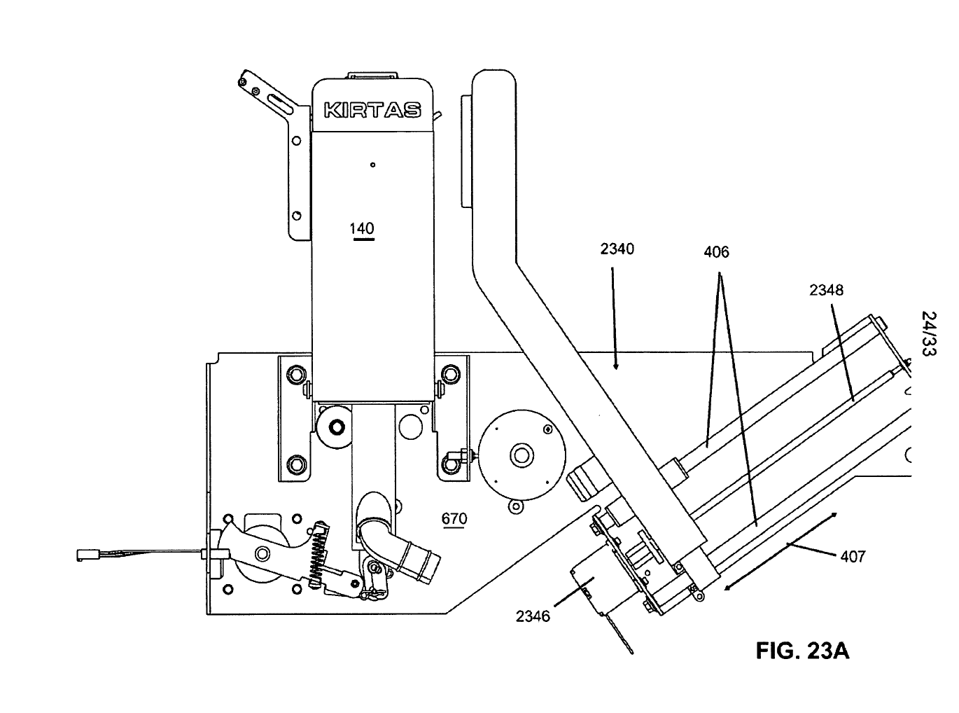

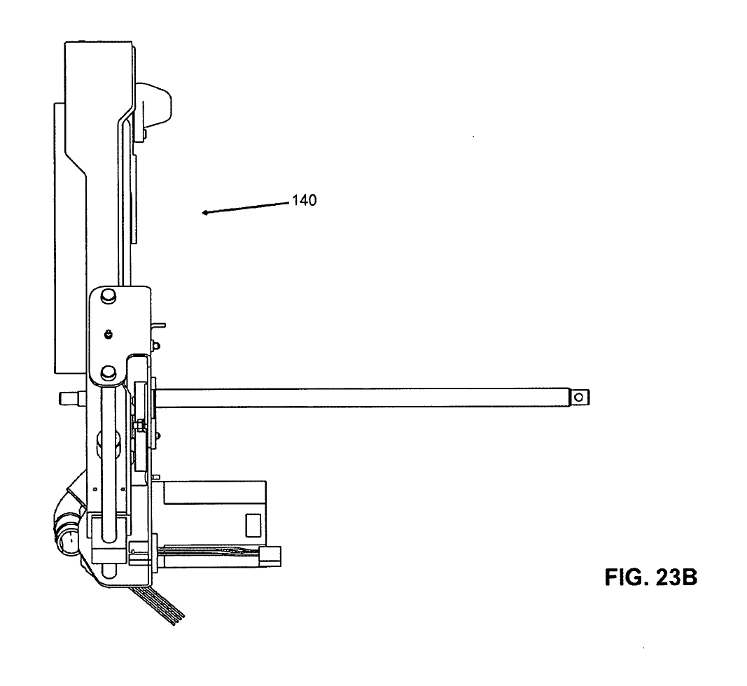

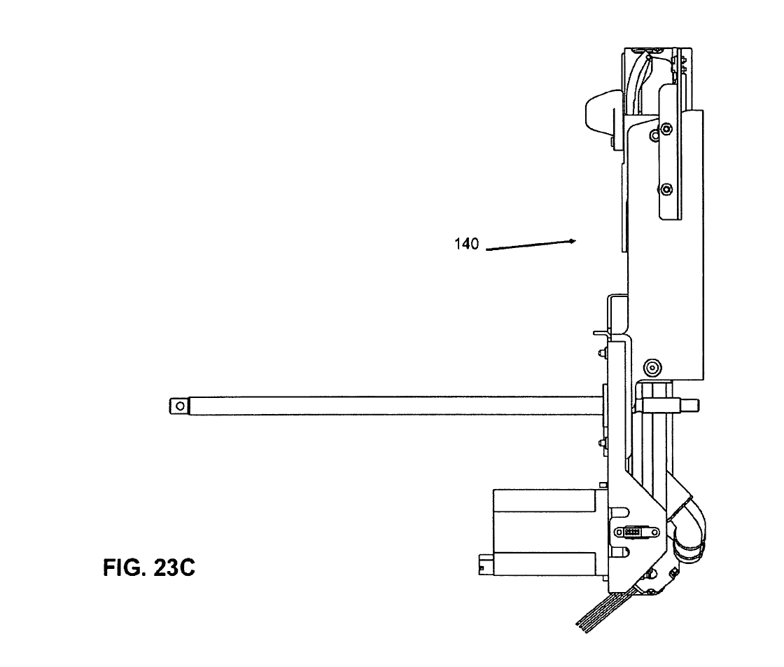

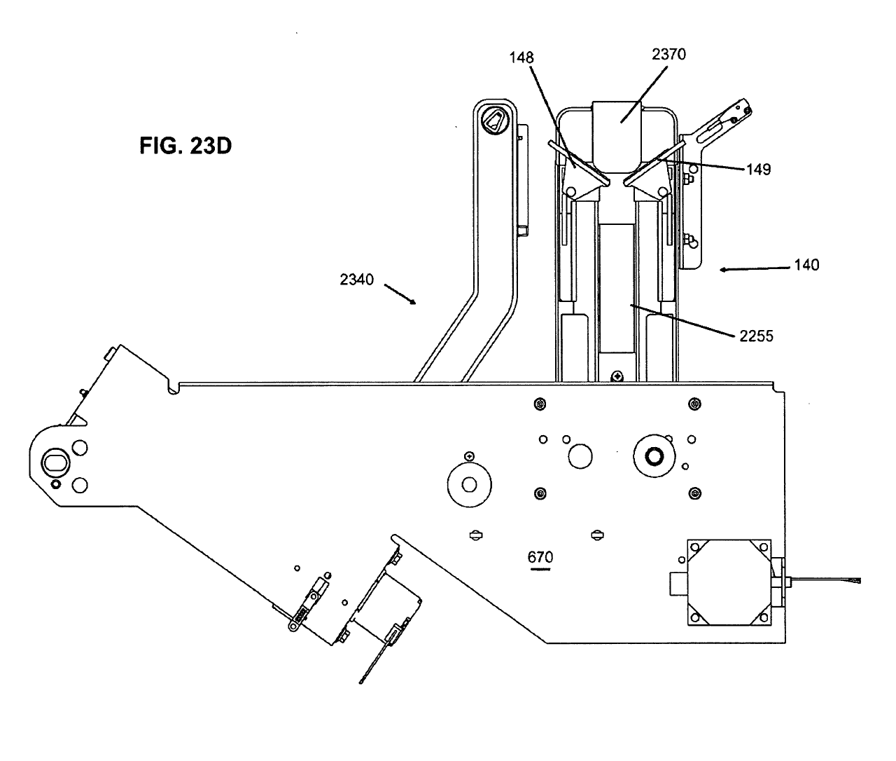

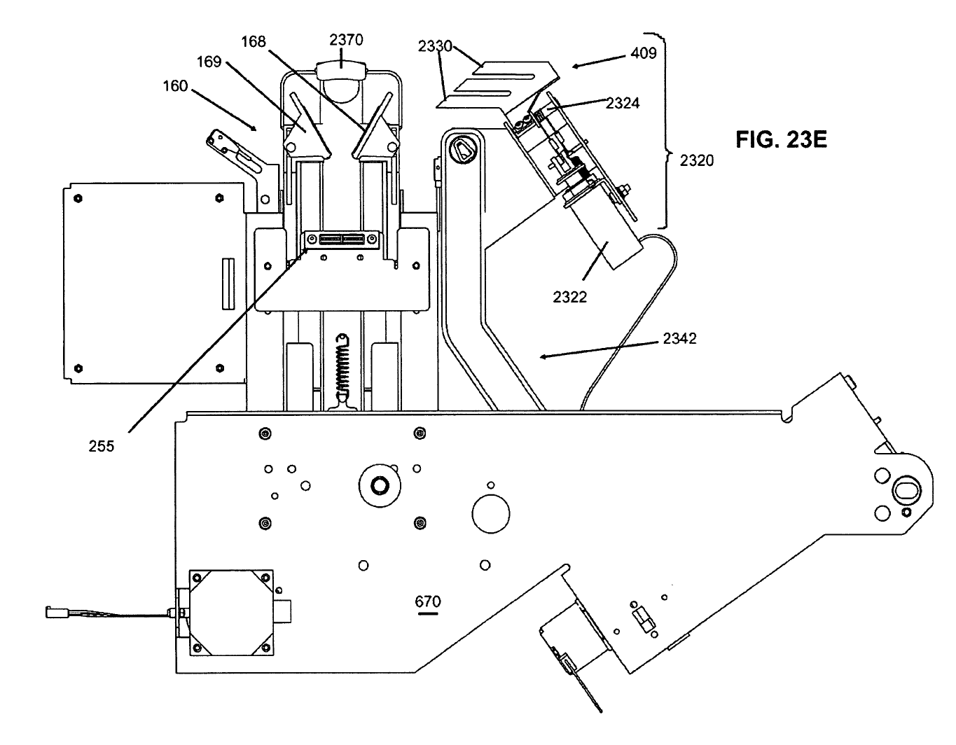

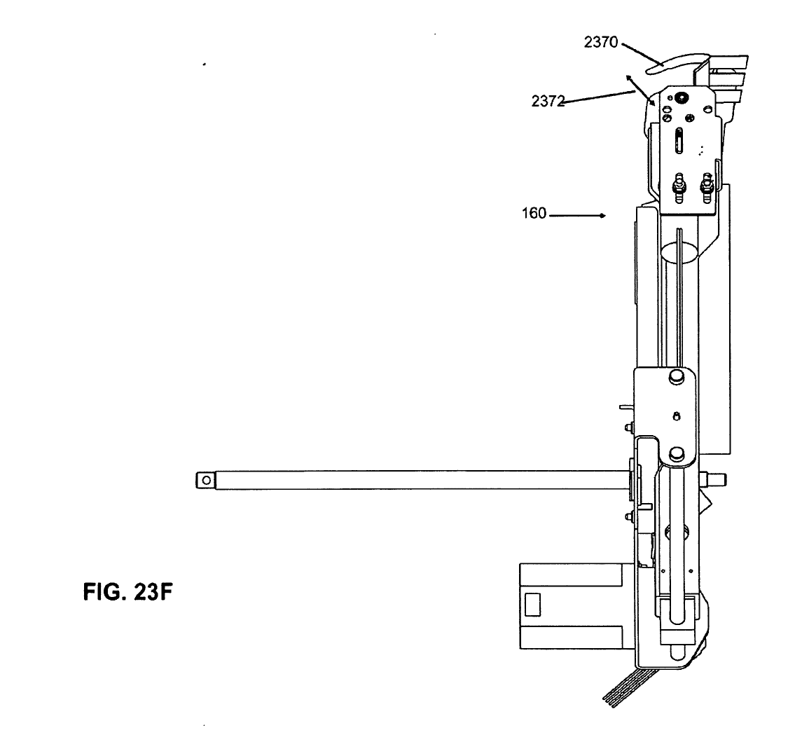

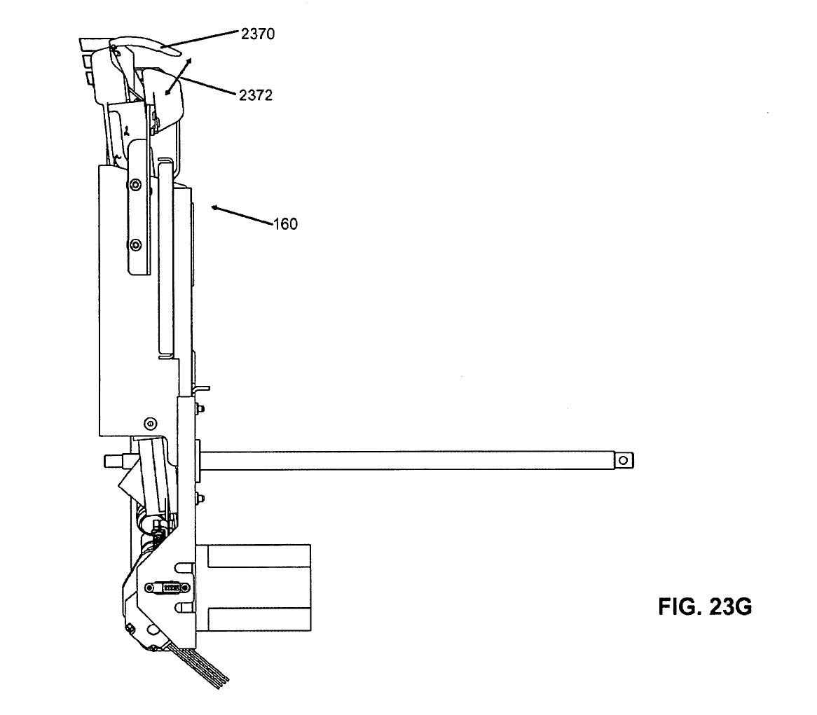

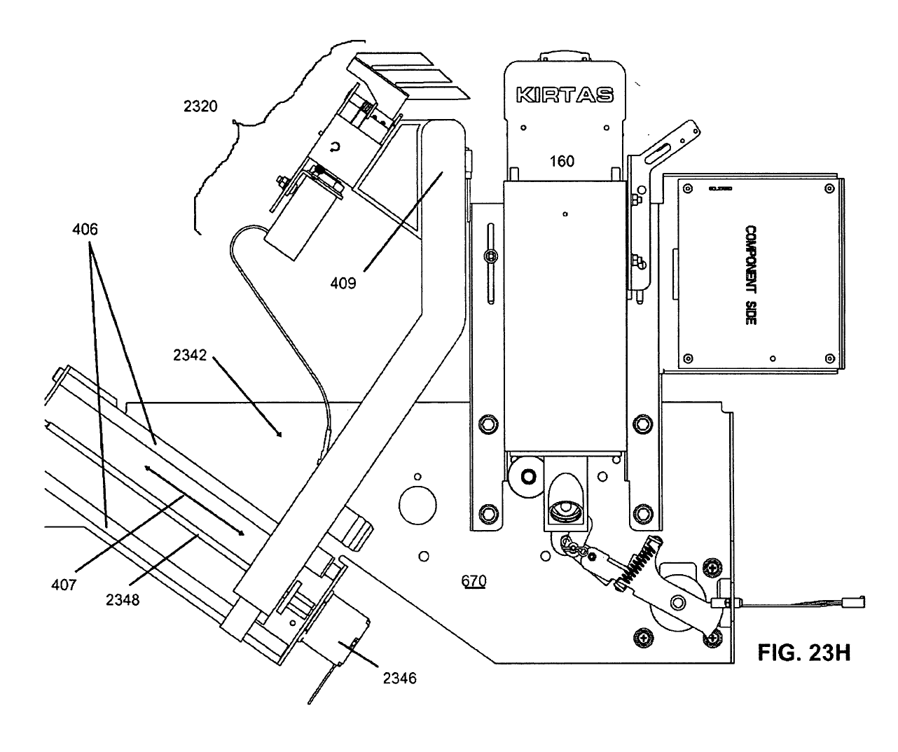

An alternative clamp design is depicted in the drawings of FIGS. 23A-H. Referring to FIGS. 23A-H, the clamps 140 and 160 operate in essentially the same manner as those described above, but the clamping mechanisms move in a direction that is either upward-outward or downward-inward. In other words, the assemblies 140 and 160 are moving in toward the pages to be clamped as they are moving downward into the contact position with spreaders 148 and 149 or 168 and 169, respectively. As a result of the multi-direction paths that the clamps 140 and 160 travel, the clamp assemblies are, when retracted and in full upright position, outside of a volume defined by the turning page, and when they are applied to the page, in the engaged position they are within the volume in order to clamp pages that have been flattened by a pneumatic or other page flattening means (e.g., FIGS. 23A-H, 24).

Furthermore, the alternative clamp assembly design includes or incorporates pneumatic (air pressure) page flattening means in the form of a “beaver tail” shaped deflector 2370. Deflector 2370 pivots about an attachment point on clamp assemblies 140 and 160, in a direction indicated by arrow 2372. When air is engaged, usually as the clamping mechanisms are moving downward-inward to initiate clamping, the air is passed through the clamp assembly and exits at a point just below the deflector 2370. In response, the deflector pivots to the position depicted in FIGS. 23F-G, where it deflects air downward onto the pages, thereby flattening the pages before and as the clamps 148-149 and 168-169 are being applied to the pages generally adjacent the bifurcation.

Optical Assembly

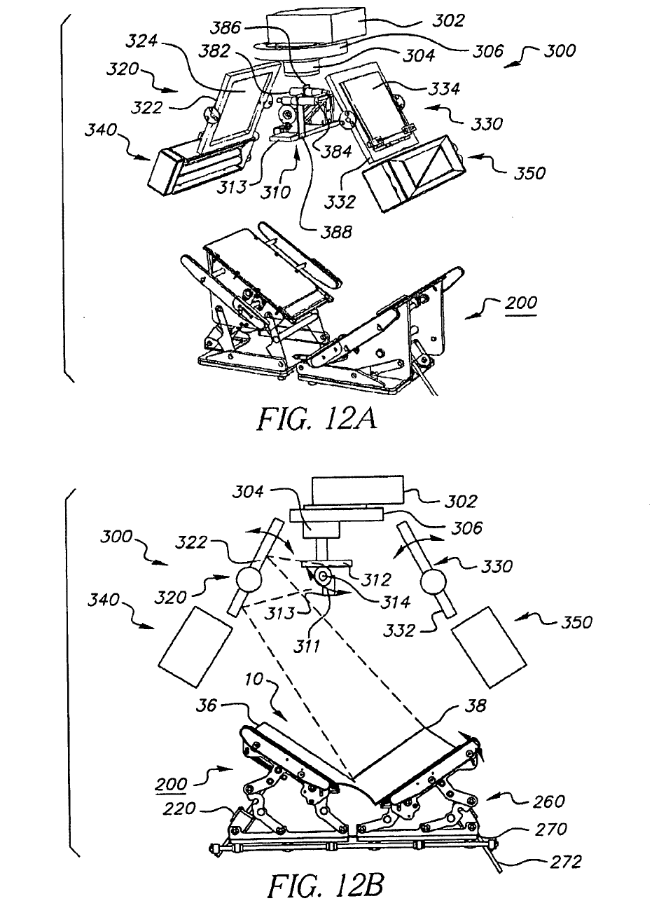

FIGS. 12A and 12B are a perspective view and an elevation view, respectively, of an optical assembly, which is used to acquire images of the open pages of a book. Although described herein as a still image camera suitable for capturing a high-resolution visual image, it will be appreciated that a closed-circuit television or similar real-time camera and associated recording means or display may be employed as well. Such a system may be used to assist the visually and physically impaired in reading books and other bound documents.

Referring to FIGS. 12A and 12B, optical assembly 300 comprises a frame 301 (not shown; see FIG. 4A), camera 302, lens 304, camera support 306, flip mirror assembly 310, recto page mirror assembly 320, verso page mirror assembly 330, left lamp assembly 340, right lamp assembly 350, front lamp assembly (not shown), rear lamp assembly (not shown), recto page ultrasonic position sensor 382 and verso page ultrasonic position sensor 384. Lighting is provided via high-frequency fluorescent lamps, which are positioned at least at the front and back relative to the cradle. Moreover, in order to assure proper illumination on various book sizes (page heights), and to reduce glare from glossy page surfaces, the front and rear lighting positions are preferably adjustable. The lighting system apparatus 100 is preferably part of the optics system 300. Front and rear lights are associated with frame 301, and are supported by a pair of parallel slides, where the slides are connected so as to cause the rear light position to move when the front light position is changed (e.g., one set of slides has linear teeth along its surface and is interconnected by a common gear, such that movement of one slide is automatically translated to the other; pulling the front light outward causes the rear light to move backward and vice-versa).

FIG. 12B further depicts book 10 comprising verso page 36 and recto page 38, held in cradle 200 with said verso and recto pages flattened into substantially planar surfaces by clamp assemblies (not shown), as previously described. For illustrative purposes, the projection of the image of recto page 38 by recto page mirror assembly 320 and flip mirror assembly 310 to camera lens 304 is shown by dotted lines in FIG. 12B. Referring to FIGS. 12A and 12B, recto page mirror assembly comprises frame 322, and mirror 324. Flip mirror assembly comprises mirror 312. In recording the image of recto page 38, said image is reflected by recto page mirror to flip mirror 312. Flip mirror 312 reflects said image to camera lens 304, which focuses said image within camera 302 preferably upon a charge coupled device (CCD) image receptor (not shown), or upon silver halide camera film (not shown), microfilm, or upon other suitable image recording medium.

Flip mirror 312 is mounted upon base 313 and is pivotable, as indicated by arcuate arrow 311. In the recording of verso page 36, flip mirror 312 is rotated clockwise approximately 90 degrees by the operation of motor 314, such that the image of verso page 36 is reflected by verso page mirror 332 to flip mirror 312, and subsequently to camera lens 304, as previously described for recto page 38.

Flip mirror assembly 310 further comprises ultrasonic sensors for detecting the positions of verso page 36 and recto page 38. (see sensor configuration described above) Referring again to FIGS. 12A and 12B, recto page ultrasonic sensor 382 and verso page ultrasonic sensor 384 are suitably mounted by support brackets 386 and 388, respectively, to flip mirror assembly 310. Recto page ultrasonic sensor 382 directs ultrasound (not shown) to recto page mirror 324, which reflects said ultrasound to recto page 38. Said ultrasound is reflected back by recto page 38 to recto page mirror 324, and subsequently to recto page ultrasonic sensor 382. Signal processing means (not shown), which are suitably connected to ultrasonic sensor 382 by shielded cable (not shown) or by wireless transmission (not shown), analyze and compare the ultrasound that is transmitted and received by sensor 382, and determine the distance between recto page 38 and recto page mirror 324. In each page turning and imaging cycle, this distance is compared to the distance required for recto page 38 to be in the focal plane of camera 302, in order to obtain a clear, focused image of recto page 38. If these distances differ by more than a specified amount, a programmable controller (not shown) operates motor 270, which rotates shaft 272, thereby adjusting the position of right cradle half 260 and recto page 38, as previously described in this specification. It will be apparent that the measurement and control of the position of verso page 36 is accomplished by substantially the same procedure, by the use of verso page ultrasonic sensor 384, and drive motor 220.

It will be apparent that many position sensing devices, other than those employing ultrasound, are known, and would be suitable as position sensing means. For example, position sensing means utilizing infrared light would be suitable. Position sensing means comprising intersecting beams of light, wherein the position of the intersection is detected would also be suitable.

Optical system 300 preferably has the additional capability to adjust its image acquisition function to accommodate books of varying page sizes. It will be apparent that a large book, i.e. a book that has a large page height and width, will require a larger field of view of the camera in order to properly record its page images, compared to a small book. Thus the camera 302 and lens 304 of FIGS. 12A and 12B are provided with the capability to zoom in and out or otherwise adjust the image area, in order to capture the full page images across a range of book sizes. However, the positions of flip mirror 312 in verso and recto page imaging must be adjusted to properly match the chosen amount of zoom. The use of a single recto imaging position and a single verso imaging position will not properly reflect the verso and recto page images to camera lens 304 across the full range of zoom positions that is required to image a variety of book sizes.

Accordingly, the position of flip mirror 312 is adjusted in order to properly reflect verso and recto page images to camera lens 304. In one embodiment, seven different zoom positions are utilized by lens 304, in order to accommodate book pages of varying size. The relative angular positions of flip mirror 312 for verso page and recto page imaging versus book width setting are provided in the table below. Other embodiments comprising more or fewer sizes, and different flip mirror angular positions, which reflect the complete images of recto and verso pages to camera 304 are also within the scope of this disclosure.

| | FLIP MIRROR POSITIONS (DEGREES FROM | |
|---|---|---|
| | A REFERENCE ANGLE DEFINED AS ZERO) | |
| Book Width | Left Angle Setting | Right Angle Setting |
| 5 inches | −48.5 degrees | 46 degrees |
| 6 | −47 | 44 |
| 7 | −46 | 43 |
| 8 | −45.5 | 42.5 |
| 9 | −45 | 42 |
| 10 | −45 | 42 |

In an alternative embodiment, depicted in FIG. 22, the images of the verso and recto pages are simultaneously directed to the camera (or other image acquisition means, such as a high resolution line scanner) by optical means other than a flip mirror. Referring to FIG. 22, and in one preferred embodiment, such optical means comprises a reflective prism 360, which is mounted upon base 313. Reflective prism 360 comprises a reflective verso face 364 and a reflective recto face 362.

In this embodiment, each pair of verso and recto pages are imaged simultaneously, wherein the image of verso page 36 is reflected from verso page mirror 334 to reflective verso face 364 of prism 360, and on to camera lens 304; while the image of recto page 38 is reflected from recto page mirror 324 to reflective recto face 362 of prism 360, and on to camera lens 304. Such an embodiment has the advantage of a significantly higher throughput in the imaging of a book.

In an alternative embodiment (not shown), a pair of mirrors is used instead of prism 360, wherein a first mirror is placed in substantially the same position as verso face 364 of prism 360, and a second mirror is placed in substantially the same position as recto face 362 of prism 360. It will be apparent that numerous other optical devices are known, such as lenses, prisms, gratings, and combinations thereof, which may serve as optical means to sequentially or simultaneously deliver the images of the verso and recto pages to camera lens 304.

In yet another alternative embodiment (not shown), a pair of cameras may be used to simultaneously acquire the page images, wherein a first camera acquires the verso page image, and a second camera acquires the recto page image.

Page Turning Assembly

The disclosed apparatus further provides an assembly for turning each page of a book, so that the apparatus can rapidly and automatically image all of the pages without manual intervention. As previously stated herein, the act of turning a page forward is defined as the sequence of contacting and grasping or acquiring with fingers, or some apparatus, a leaf comprising a recto page, and pivotally rotating said page about its bound edge, until the surface of said page is in contact with the surface of the former verso page, and the exposed surface of the rotated leaf is the new verso page. In the preferred embodiment, pages are turned forward, so that page images are acquired sequentially, beginning at the front of a book, and ending at the back of a book.

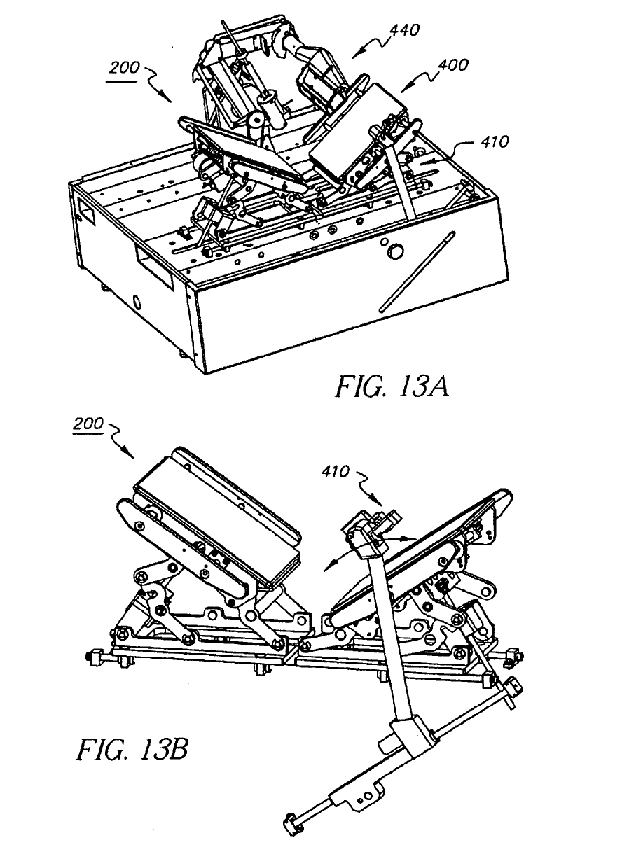

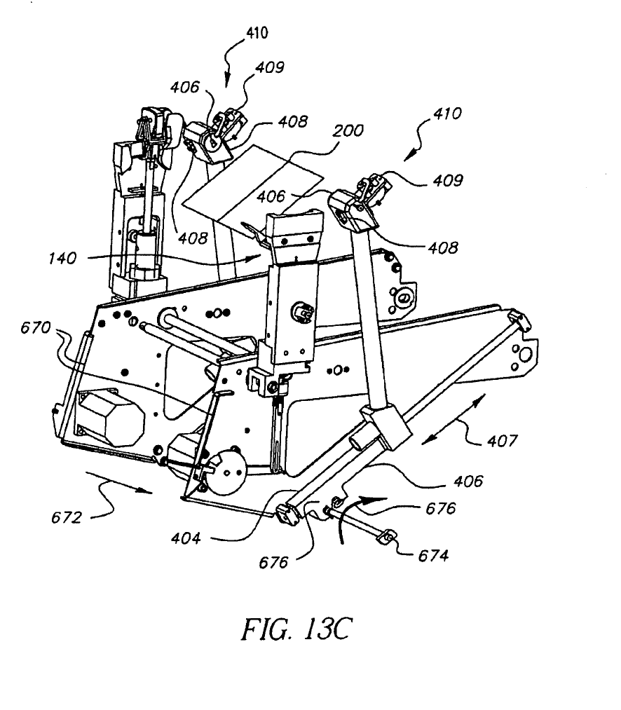

FIGS. 13A and 13B are perspective views of part of the apparatus, further depicting a cradle assembly 200, and a page turning assembly. Page turning assembly 400 preferably comprises a page fluffer 410 and a page turner 440. Immediately after the completion of an imaging cycle, i.e. after images of the pair of open pages are acquired, page fluffer 410 separates the leaf comprising the recto page, and page turner temporarily attaches to the upper surface of the leaf and turns the page, thereby producing a new verso page and new recto page to be imaged.

Referring also to FIG. 13C, there is depicted an alternative embodiment for the cradle, page fluffing and clamping assemblies. In particular, the alternative embodiment includes a pair of page fluffers 410, positioned adjacent to the front and rear edges of the recto leaf. Also associated with the head or end of page fluffers 410 are two additional components—page level sensors 408 and retard fingers 409. Page level sensors 408 are preferably photoelectric sensors such as SUNX CX-23 sensors, wherein beams of light are sent from a rear-mounted emitter to a front-mounted detector so that the level or position of the recto page may be detected. In an alternative embodiment, the sensors may be reflective type sensors, where the emitter and detector are co-located. Similar sensors may be provided for the verso page (not shown) and are preferably mounted in association with the clamp or similar device positioned adjacent the verso leaf.

In one embodiment, one or more retard fingers 409 may be used to hold the right-hand or recto page down as the top page is being turned. In the figure, the front retard finger is shown in a withdrawn or retracted position, whereas the rear retard finger is shown in an operative position, where it would serve to prevent the page from turning. Also referring to FIGS. 23A-C, there is depicted an alternative version of such a retard finger in the nature of a page corner snubber 2320 for use with the disclosed page turning system. Specifically, FIG. 23A illustrates the page corner snubber and shows the corner of the page being bent or retarded by the snubber finger as the pages are being lifted. FIG. 23B shows the corner snubber finger in the down (operative) position, whereas FIG. 23C shows the finger in the up (retracted) position.

In particular, the corner snubber 2320 operates to deflect a corner of the page when the page is being turned as described herein. In one embodiment, the finger 409 is moved, as depicted in FIGS. 23A-C using a solenoid 2322, or similar electro-mechanical or pneumatic device, to rotate the pivoting rod 2324. Operation of the solenoid 2322 is intended to permit the finger 409 of corner snubber 2320 to be operatively rotated into and out of snubbing position, so as to avoid having the finger 409 appear within the page image when the turned pages are imaged. It will be appreciated that the finger 409 may not only swing or move in an up-down direction, but alternatively or also in an in-out direction, dependent upon the constrains of adjacent equipment, the nature of the documents being turned, etc.

The nature of finger(s) 409, particularly in the embodiments depicted in FIGS. 23E-H is such that a plurality of fingers are employed (to assure contact at or very near a corner of the turning page(s) and the finger is more flexible near the tip 2330 where the finger contacts the pages and page edges, and more rigid near the base where it is attached to the pivoting rod 2324. Ideally, the finger will operate to bend the corners or edges of the pages, and thereby stop subsequent pages from following the top page being turned. Finger 409 may be manufactured from metal or plastic materials (e.g., shim stock or the like), and combinations thereof, to achieve a desired flexibility for at least the end of the finger. As illustrated in FIG. 23H, for example, the snubber 2320 may be affixed to the movable page fluffer 408, whereby the position of the snubber is adjusted according to the book or page size so that the fluffer coincides with the corner of a page being turned.

As will be appreciated from a review of FIG. 13C, the fluffer assembly 410 is mounted on a slide 406 to enable its position adjustment for page width, by moving the fluffers in the direction of arrow 407 along shaft 404, preferably at the time a book is loaded. Although the details of the rear fluffer mounting mechanism are not illustrated, it will be appreciated that similar mechanism may be employed for the front and rear fluffer assemblies in the embodiment of FIG. 13C.

Referring again to FIGS. 23A-H, alternate fluffer assemblies 2340 (front) and 2342 (rear) are automatically moved under the control of the processor or controller for the page turning system. In response to signals from the processor and an associated motor driver, motor 2346 operates a lead screw 2348 to move the fluffer in the direction of arrow 407. In one embodiment, the fluffer is automatically adjusted in accordance with the size of the page being turned. The fluffers 2340 and 2342 are automatically moved to an optimum location, depending on the book page width (binding to edge distance). This optimum location is largely a function of the book page size, and the position varies from about 65% to about 90% of the distance from the binding or spine of the book.

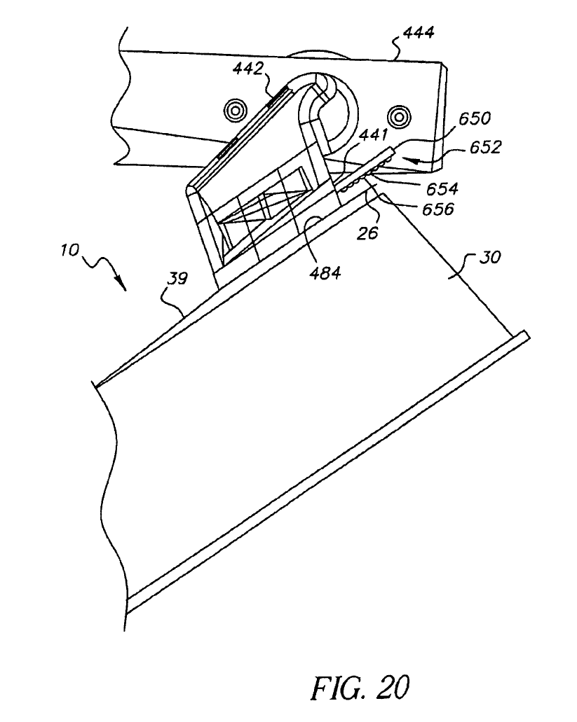

In one embodiment, the book page size could be input by the operator, or it may be detected automatically by a sensor located on the cradle, by the page edge sensor located on the vacuum head (see FIG. 20; e.g., phototransistor array 650), by imaging or other sensors suitable to detect the edge, or combinations thereof. Alternatively, or in addition to the automated adjustment of the fluffer position, the operator may also adjust the fluffer position via a button or similar control on the user interface (computer screen and/or a physical button, rocker switch, etc.) in order to fine tune the optimum position based upon other factors relating to the characteristics of the page (e.g., paper thickness, paper stiffness, etc.). As will be appreciated, the rods 406 are generally parallel with the cradle surface so the fluffer slides along the rods in a direction generally parallel with the pages of the book.

FIG. 13C also shows that the fluffers 410 and clamp assemblies 140 and 160 are, respectively, located on common structures 670. Structures 670 are further able to translate or adjust relative to one another, in direction 672 in response to the rotation of a screw-shaft 674 in the direction indicated by arrow 676. The screw-shaft may be equipped with a crank (not shown) to provide such translation and allow a user to adjust the fluffers and clamps for different height books. By mounting the front and rear fluffer and clamp assemblies on common structures, the position of each assembly is controlled by a single adjustment.

In FIG. 13C, front clamping mechanism 140 is also preferably a pivotable mechanism that, once unlocked, is able to be tilted out of the way (pivots/tilts downward) in order to facilitate loading of a book from the front of the apparatus. Furthermore, when a page is clamped by the clamping mechanism, the spreaders 148 and 149 (e.g., FIG. 10C), are placed on the margins of the pages to hold them in position for imaging. In one embodiment, the top surface of spreaders 148 and 149 are painted a particular color or pattern that can be easily recognized by image processing software receiving and operating on an image generated by the camera. In this way, the software may operate on a page image in order to automatically “remove” the spreaders from the image (margins), preferably replacing the spreader with an image color similar to a non-clamped margin region. Having described various embodiments of the page fluffers and page turner, the operations of page fluffer 410 and page turner 440 are now presented in detail.

As described herein, various operations may be accomplished by a programmable controller, preferably in response to inputs, which may include sensor signals. For example, sensing means such as the sensors described above, or similar optical sensors (e.g., reflective sensors) suitable for detecting one or more page edges, may be used to detect the location of the open pages of the book or document. Sensors of this type may be further employed to indicate the boundary of at least one edge of a page, and the signal from said sensor may be employed by the controller to automatically indicate and/or output the location of the edge so as to control cropping of an image produced by the camera, or to adjust the position of the vacuum head for acquisition and turning of the next page.

It will be further appreciated that such sensors, or the optical imaging camera, may be further employed to sense a page inserted (e.g., colored page or page having a particular pattern) or a tab attached to an existing page, or an equivalent material that extends beyond a page edge. Upon detection of such a material (e.g., insert or tab), the sensor may be used to signal the controller in response to the sensing of the material, thereby causing the controller to alter an operational cycle of the apparatus. For example, the signal may be used to stop operation entirely, to alter the operation by skipping pages until another insert or tab is detected, or to alter the scanning/imaging parameters (e.g., to scan at a different resolution because images are found on the tabbed pages). In yet a further modification of the sensors, they may be used to sense the opacity of pages that are acquired. In this way, the typical page opacity may be determined and any opacity (occlusion) of a greater level may be determined to be acquisition of multiple pages by the vacuum head—thereby requiring that operation stop for manual intervention, or that the process otherwise be altered to assure that the pages are separated before proceeding (e.g., fluffers are engaged, re-engaged, etc.). It will be appreciated that this function may be accomplished by an optical sensor in conjunction with the controller, wherein the sensing means is capable of sensing the opacity of the page acquired by the vacuum head and providing a signal indicating the opacity to the controller, and where the controller determines if multiple pages have been acquired by the vacuum head as a function of the opacity signal.

Although described generally relative to an opacity sensor (sensing the level of ambient light that is transmitted through the sheets acquired by the vacuum head as described relative to FIG. 20, the edge sensor may also include or utilize a capacitive sensor for edge detection, multi feeds (e.g., change in light level or capacitive level above a threshold would indicate multiple sheets were acquired), a loose sheet (loose page in book such that no foreshortening of page is sensed when the page is turned), sheet drop (loss of sheet after initial acquisition). Moreover, in the manner described above, the sensor may be employed to cause an automatic stop in response to sensing of flag stuck on page to signal stop scanning subsequent pages.

In the alternative embodiment, employing a capacitive sensor, the presence and/or change in surface charge on the pages as sensed by the capacitive sensor may be employed to indicate the loss of a page previously acquired, the presence of multiple pages, etc. The capacitive sensor may be located within the vacuum head and the charge sensed will vary based upon the type and nature of the document pages. It will be appreciated that the capacitive sensor, like the optical (opacity) sensor, may require calibration, either periodically or on a book by book basis to assure that the controller analyzing the output of the sensors is capable of determining when a single page is acquired versus a lost page and multiple pages. Such calibration may be based upon an initial successful page turning and scanning operation, in other words, self-calibration based upon first page(s) being turned. It is also possible that the use of both the optical sensor and the capacitive sensor may be employed in a complimentary fashion to permit the improved detection of any page-turning errors, etc.

In another embodiment, the machine may be programmed to operate in a manner whereby pages are pulled outward (away from the spine) when being turned to improve the flatness of pages that have been turned. In doing so, the page may tend to “slip” along the vacuum head when it is pulled tight, and the detection of movement of the edge may provide an indication that the page has been pulled tight. Furthermore, the absence of any change in the location of the page edge relative to the edge sensor or vacuum head, may also signal the presence of a loose page. Such a page may require manual intervention, or may be handled by an early release of the page in the turning sequence, to thereby permit the page to return or reseat along the gutter or spine.

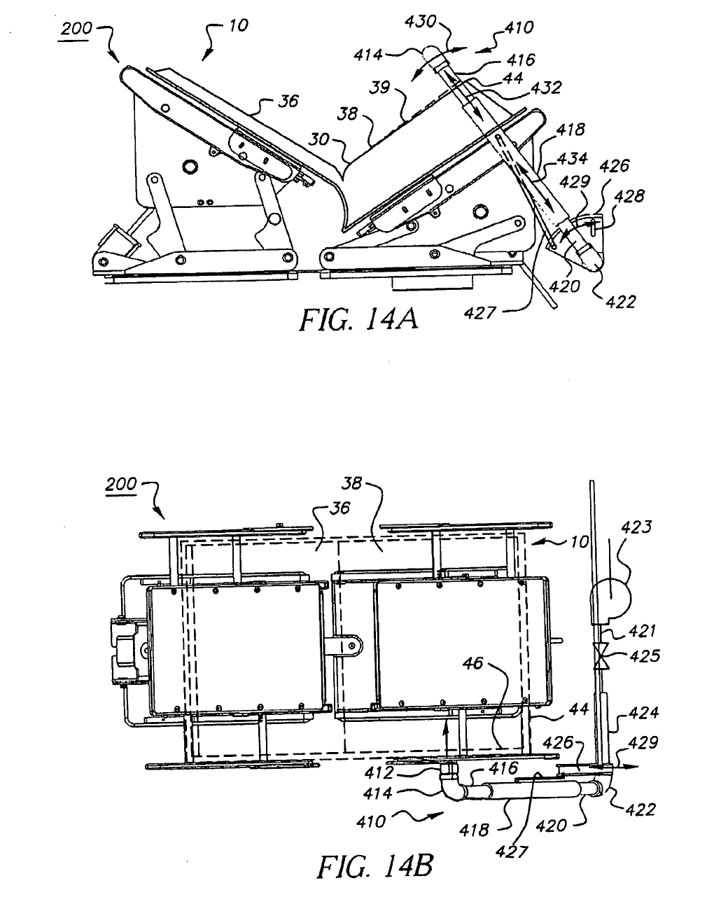

FIG. 14A is a front elevation view of a cradle assembly and a page fluffer of the apparatus, further depicting a book held by the cradle assembly. FIG. 14B is a top view of the cradle assembly and page fluffing assembly of FIG. 14A. Referring to FIGS. 14A and 14B, fluffer 410 comprises nozzle 412, upper elbow 414, upper supply pipe 416, outer supply pipe 418, lower supply pipe 420, lower elbow 422, pivot pipe 424, pulley support 426, and air (gas) supply piping 421 (shown schematically), which is operatively connected to pivot pipe 424, to valve 425 (shown schematically), and to air supply blower 423 (shown schematically). Pivot pipe 424 is pivotably joined to pulley support 426, such that fluffer 410 may be pivoted about the central axis of pivot pipe 424, as indicated by arcuate arrow 430.

The outer diameters of upper supply pipe 416 and lower supply pipe 420 are slightly larger than the inner diameter of outer supply pipe 418, such that upper supply pipe 416 and lower supply pipe 420 are slidably engaged within outer supply pipe 418. Accordingly, the position of nozzle 412 may be adjusted relative to book 10 by motions of upper supply pipe 416 and outer supply pipe 418 along their common central axis, as indicated by arrows 432 and 434, respectively.

Such adjustment is accomplished by the rotation of pulley support 426, which is actuated by fluffer orienting rod 428. When pulley support 426 is rotated by the operation of fluffer orienting rod 428 around pivot pipe 424, as indicated by arrow 426 of FIGS. 14A and 14B, linkage rod 427, which is operatively joined to pulley support 426 and to outer supply pipe 418 is actuated in the general direction of arrow 434, resulting in the sliding of outer supply pipe 418 upon lower supply pipe 420. Thus the position of fluffer nozzle 412 with respect to book 10 is rendered adjustable.

In operation of fluffer 410, at the beginning of a book imaging cycle, the position of nozzle 412 is adjusted such that it is proximate to the corner 44 of the text block 30 of book 10. Immediately after each imaging cycle thereafter, page fluffer 410 separates the leaf comprising the recto page 38 from the remainder of the text block beneath recto page 38, by directing a jet of fluffing air toward the corner 44 of book 10 in a direction substantially perpendicular to the edge 46 of text block 30. Said fluffing air is preferably provided by a air supply blower 423, and started and stopped by operation of valve 425 (shown schematically in FIG. 14B). Said fluffing air is typically ambient air, although the air may also be treated for humidity or other characteristics to improve operability.

In one embodiment, said fluffing air consists essentially of dry compressed air. In yet another embodiment, wherein book 10 is a rare and delicate book, the apparatus may be enclosed in a chamber filled with inert gas, and the fluffing gas may also consist essentially of an inert gas, such as nitrogen, argon, and the like.

The direction of a jet of fluffing air at the corner 44 of text block 30 results in recto page 38 being separated from the adjacent pages beneath recto page 38, as indicated by fluffed leaf 39 shown in dotted line format in FIG. 14A. Such separation facilitates the attachment of page turner 440 to fluffed leaf 39, prior to page turning.

Alternative embodiments are directed to the use of adaptive air fluffers for separating a leaf comprising a page to be turned from the text block therebeneath. Patent application Ser. No. 10/389,051 of Belkhir, discloses a page turning apparatus for turning at least a top page of a stack of pages in a book, comprising means for holding the book; an air plenum, positioned above the top page, for picking up the page when a vacuum is applied to said plenum; and a paper fluffer for blowing air between individual pages of the book, said paper fluffer including means for adjusting air flow between individual pages, said paper fluffer having a venturi plate portion in contact with at least one edge of the page, and said paper fluffer including a regulating plate portion with an aperture defined therein that permits air to go through and a cross-sectional area that limits air flow as the top page moves in contact with said air plenum. The use of such a paper fluffer is to be considered within the scope.

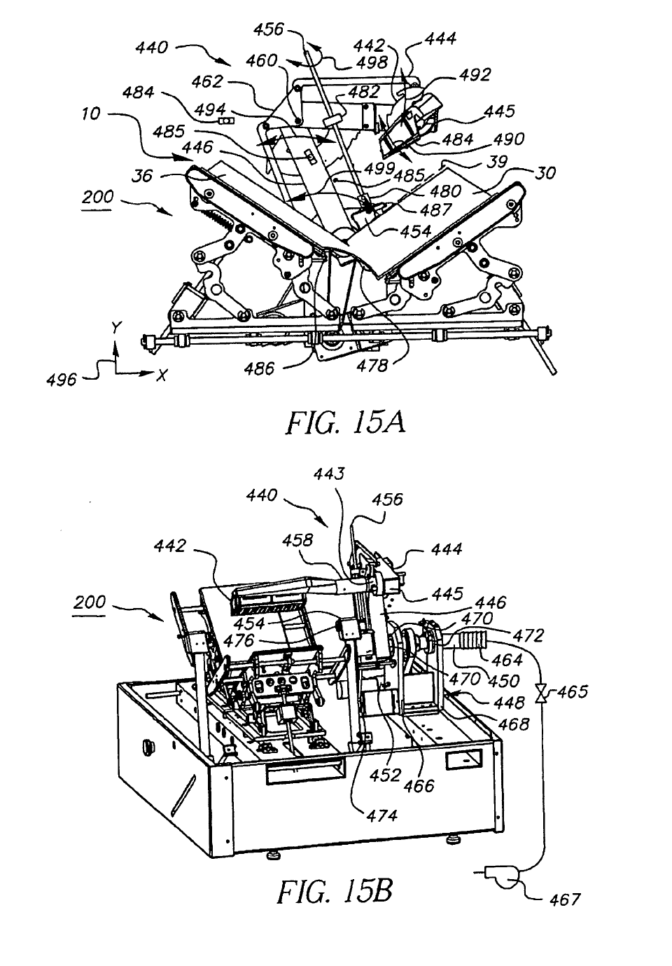

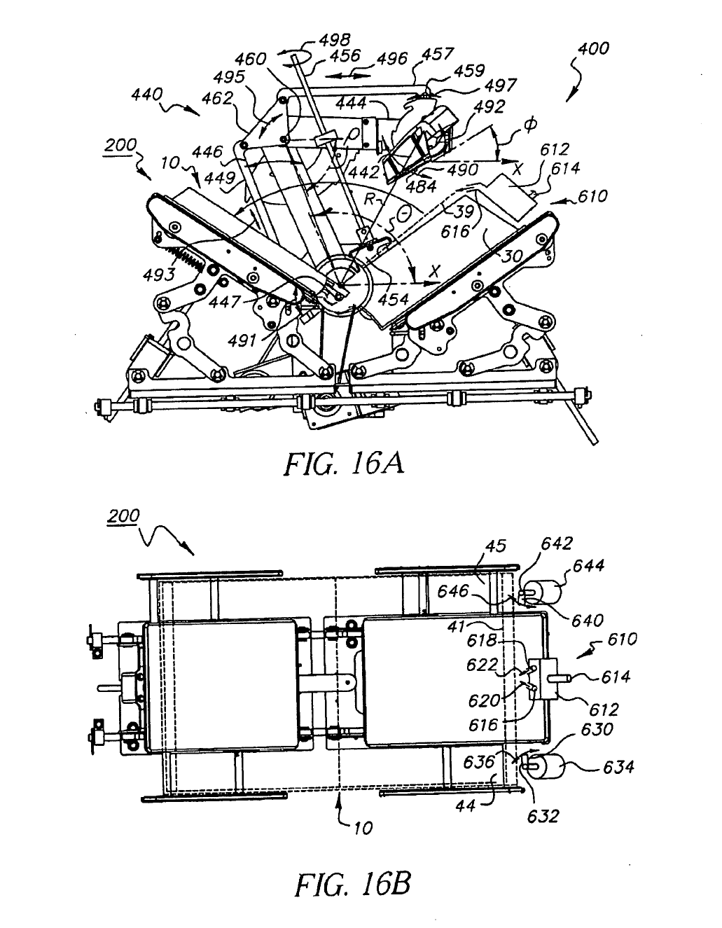

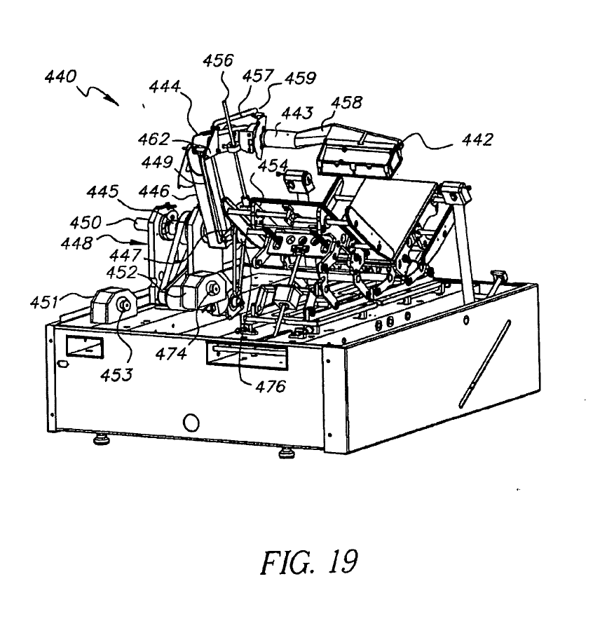

Following the fluffing of verso page 38 to produce fluffed leaf 39, the page is turned. FIG. 15A is an elevation view of a cradle assembly and a page turner of the apparatus, further depicting a book held by the cradle assembly. FIG. 15B is a right front perspective view of a cradle assembly and a page turner of the apparatus. FIG. 16A is a front elevation view of a cradle assembly and a page turner, depicting the geometric relationships between components thereof. FIG. 19 is a left front perspective view of a cradle assembly and a page turner of the apparatus, further showing three drive motors used to operate the page turner. These elevation and perspective views best depict the operation of the page turner, and should be considered in combination for an understanding thereof.

Referring to FIGS. 15A and 15B, page turner 440 comprises vacuum head 442, upper arm 444, lower arm 446, pivot block assembly 448, pivot tube 450, vacuum head drive motor 452, upper arm drive motor 454, and lead screw 456. Vacuum head 442 further comprises outlet sleeve 458, which is sealed and rotatably engaged with vacuum tube 443. Hence vacuum head 442 is pivotably engaged with vacuum tube 443, as indicated by arcuate arrow 490. Vacuum tube 443, comprising a thin-wall hollow tube, is joined and sealed to upper arm 444. Upper arm 444 further comprises a thin-wall substantially rectangular or square hollow member, with a cap 445 sealably fitted to the cantilevered end of upper arm 444. Vacuum tube 443 further comprises at least one passageway at its junction within upper arm 444, such that the interior passageway within vacuum tube 443 is in communication with the interior passageway of upper arm 444.

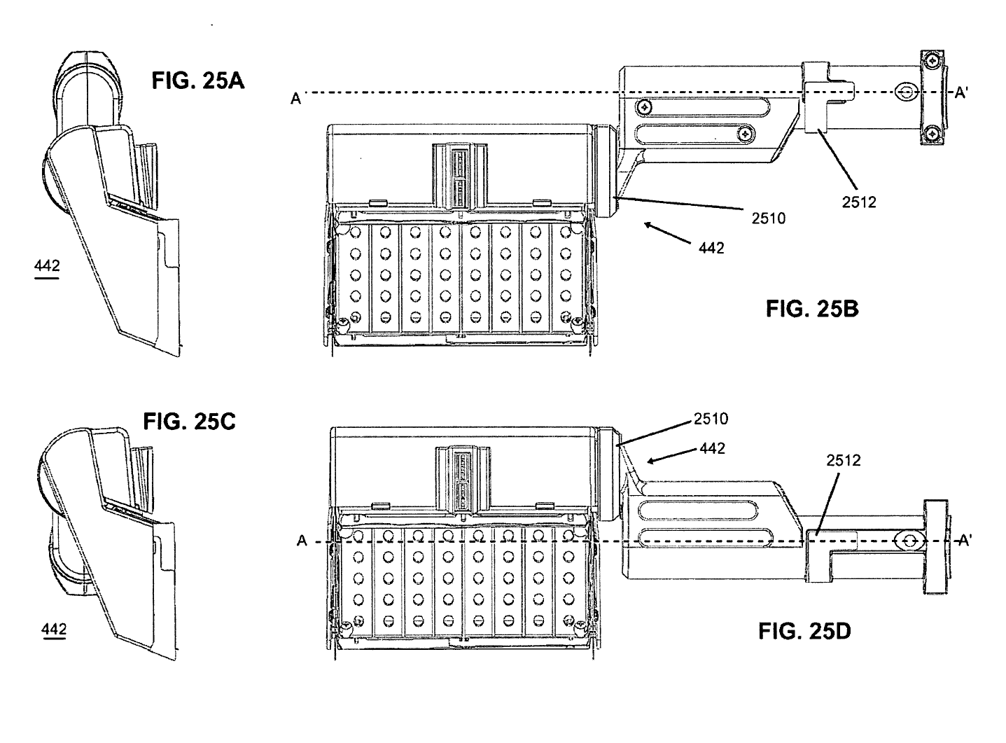

Referring also to FIGS. 25A-D, vacuum head 442 is depicted in an alternative configuration, where as a result of rotatable connection links 2510 and 2512, the position of the head relative to the support arm, and therefore the outer edge of the book page, may be adjusted. By turning both of the links approximately 180-degrees offset section 2530, located between the links, is moved to place the vacuum head inward (toward the book binding) in FIGS. 25A and 25B, our outward (away from the book binding) as in FIGS. 25C and 25D. The dashed line A-A′ in FIGS. 25B and 25D provides a comparative illustration of the amount of offset (approximately 2-3 inches) between the inward and outward positions for the vacuum head. Such an adjustment permits the accurate placement and operation of the vacuum head for different pages sizes found in various books, thereby increasing the range of books that may be acquired and turned under the assistance of the adjustable vacuum head.

Alternative or multiple offset may be employed to facilitate a plurality of adjustment positions between a minimum and maximum. It will also be appreciated that other adjustable vacuum head mounting mechanisms may be employed in order to provide similar adjustability relative to arm 444 (not shown in FIGS. 25A-D).

Upper arm 444 is pivotably joined to lower arm 446 by pivot shaft 460, such that upper arm 444 is pivotable with respect to lower arm 446 as indicated by arcuate arrow 492. In further description within this specification, the angle between upper arm 444 and lower arm 446 is referred to as the rho (ρ) angle. Such rho angle is depicted in FIG. 16A.

Referring again to FIGS. 15A and 15B, lower arm 446 comprises a thin-wall hollow member as described for upper arm 444, with a cap (not shown) sealably fitted to its lower end, also as described and shown for upper arm 444. The ends of lower arm 446 and upper arm 444 proximate to each other and joined by pivot shaft 460, are enclosed within a flexible bellows sleeve (not shown), which is sealed to said ends of lower arm 446 and upper arm 444. Thus, said flexible bellows renders the internal passageway of lower arm 446 in communication with the internal passageway of upper arm 444.

Lower arm 446 is further joined and sealed to pivot tube 450, which further comprises a thin-wall hollow tube having at least one passageway at its junction within lower arm 446. Thus the interior passageway within pivot tube 450 is in communication with the interior passageway of lower arm 446. Pivot tube 450 is connected at its distal end to flexible tubing 464, which is further connected to vacuum valve 465 (shown schematically) and vacuum blower 467 (shown schematically). During the page turning process, vacuum blower 467 sucks air (or inert gas if such is present) from close proximity to leaf 39 into vacuum head 442, through vacuum tube 443, through upper arm 444 and adjoining bellows (not shown), through lower arm 446, through pivot tube 450, and out of the apparatus through flexible tubing 464.

Pivot block 448 comprises front bearing plate 466 and rear bearing plate 468, which house bearings 470 and 472, respectively. Pivot tube 450 is supported by bearings 470 and 472, and is therefore rotatably mounted within pivot block 448. Accordingly, lower arm 446, being joined to pivot tube 450, is pivotable about the central axis of pivot tube 450, as indicated by arcuate arrow 494.

In further description within this specification, the angle between lower arm 446 and the x-axis as previously defined in this specification and indicated in FIG. 16, is referred to as the theta (θ) angle. Referring to FIG. 19, in operation of the apparatus during a page turning cycle, such pivotal motion is provided by motor 451. Drive pulley 453 is mounted on the shaft (not shown) of motor 451, and is operatively coupled by a pulley belt (not shown) with driven pulley 455, which is joined to pivot tube 450. Thus the rotation of motor 451 results in the variation of the theta angle, i.e. pivotal motion of lower arm 446, and all components attached thereto.

The pivotal motion of upper arm 444, relative to lower arm 446, is also motor driven in the present embodiment. Referring to FIGS. 15A and 15B, motor 454 is pivotably joined to pivot bracket 478, which in turn is joined to lower arm 446. Motor 454 is operatively joined to lead screw 456 by shaft coupling 480. Lead screw 456 is threadedly engaged with lead nut 482, which is pivotably joined to upper arm 444. Thus motor 454 rotates lead screw 456 as indicated by arcuate arrow 498, which drives pivotal motion of upper arm 444 and components attached thereto with respect to lower arm 446.

The operation of motor 454 controls the rho angle as defined previously in this specification and shown in FIG. 16A. It will be understood that as motor 454 controls the rho angle, motor 454 also controls the value of R, also shown in FIG. 16A. R is defined as the distance between the axis of pivot tube 450 (see FIG. 15B) and the axis of vacuum tube 443 (see FIG. 15B). Noting that vacuum head 442 is operatively joined to vacuum tube 443, it will be understood that motor 451 (see FIG. 19) and motor 454 thus control the position of vacuum head, defined in polar coordinates and referenced to the axis of pivot tube 450. The theta (θ) angle, controlled by motor 451, defines the angular position of vacuum head 442 with respect to the axis of pivot tube 450. The value R, controlled by motor 454, defines the radial position of vacuum head 442 with respect to the axis of pivot tube 450.

Thus, by the operation of motors 451 and 454, vacuum head 442 is brought into close proximity to fluffed leaf 39 of book 10, depicted in FIG. 16A. However additional control of vacuum head is required. In order for vacuum head 442 to properly acquire fluffed leaf 39 from book 10, the lower portion 484 of vacuum head 442 must be aligned such that lower portion 484 of vacuum head 442 is substantially parallel with a portion of fluffed leaf 39. In the following description, the angle between lower portion 484 of vacuum head 442 and the x-axis is referred to as the phi (φ) angle. Such an angle is depicted in FIG. 16A, and is a measurement of the alignment of the lower portion 484 of vacuum head 442 with fluffed leaf 39 of book 10. It will be further appreciated that the angle at which the pivotable vacuum head is pivoted is variable (e.g., in accordance with the type of paper stock used for the page) and may be adjusted so as to assist in the separation of an acquired open page. In other words, the vacuum head, once the page is contacted, may be pivoted so as to force the acquired page or leaf away from underlying, adjacent pages and thereby assist in the separation of the pages.

In one embodiment, such alignment is provided by the use of an additional drive motor and linkage as depicted in FIGS. 16A and 19. Referring to FIGS. 16A and 19, motor 452 provides such aligning motion. Drive pulley 474 is mounted on the shaft (not shown) of motor 452, and is operatively coupled by a pulley belt (not shown) with driven pulley 476, which is rotatably mounted on the lower end of lower arm 446. Link 447 is joined to drive pulley 474, and is therefore pivotable with respect to the lower end of lower arm 446. Linkage rod 449 is joined at its lower end to link 447, and at its upper end to link 462, which is pivotably mounted upon pivot shaft 460. In like manner, linkage rod 457 is joined at a first end to link 462, and to link 459, which is joined to vacuum tube 443.

It will be understood therefore, that the forward and reverse motion of motor 452 will produce the motion of link 447, indicated by arcuate arrow 491; which produces the motion of linkage rod 449 indicated by arrow 493; which in turn produces the motion of link 462 indicated by arcuate arrow 495; which in turn produces the motion of linkage rod 457 indicated by arrow 496; which in turn produces the motion of link 459 indicated by arcuate arrow 497; which in turn produces the pivotable motion of vacuum head 442 indicated by arcuate arrow 490. Thus the operation of motor 452 controls the phi (φ) angle, and accordingly, the alignment of the lower portion 484 of vacuum head 442 with fluffed leaf 39 of book 10.

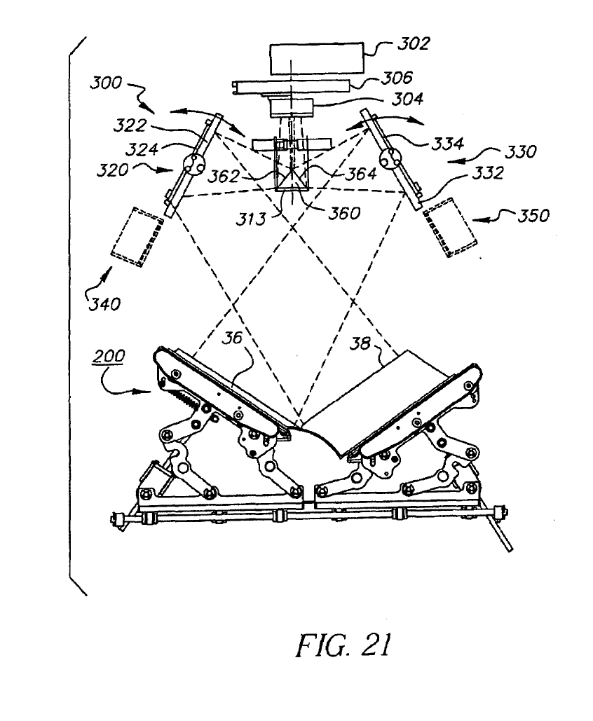

In the execution of a page turning cycle, which follows an imaging cycle, motors 451 and 454 are operated to control the angular and radial positions of the vacuum head 442, and motor 452 is operated to control the alignment of lower portion 484 of vacuum head 442, such that the lower portion 484 of vacuum head 442 is brought into close proximity with fluffed leaf 39 of book 10, as depicted in FIG. 21. The effect of gas flowing into vacuum head 442 through the interstice between vacuum head 442 and fluffed leaf 39 results in fluffed leaf 39 being drawn upwardly to the lower portion 484 of vacuum head 442. Fluffed leaf 39 is temporarily, gently acquired against the lower portion 484 of vacuum head 442 by the pressure differential between the ambient atmosphere present, and the vacuum within the interior of vacuum head 442.

Vacuum head 442 may be a vacuum head having a corrugated surface, which enables such vacuum head to more effectively acquire fluffed leaf 39. Such vacuum heads, also known as adaptive air plenums, are well known in the art. For example, U.S. Pat. No. 6,398,206 B1 of Taylor et al., issued Jun. 4, 2002, discloses a sheet feeding apparatus having an air plenum with a corrugated surface, comprising a first set of ribs at a first height and a second set of ribs at a second height, which corrugates and separates a top paper sheet from a stack of paper sheets therebelow. U.S. Pat. No. 6,398,208 B1 of Taylor et al, also issued Jun. 4, 2002, discloses a sheet feeding apparatus having an air plenum with a corrugated surface and with a leaky perimeter seal, which corrugates and separates a top paper sheet from a stack of paper sheets and seals thereto. The disclosures of each of these United States patents are hereby incorporated herein by reference.

Additional aspects of the embodiment are directed to the application of a vacuum head having a corrugated surface as an aid to the separation and turning of pages in an open-book scanner. Scanners of the type in which the present application find a particular use are described, for example, in the following patents U.S. Pat. No. 6,056,258, U.S. Pat. No. 5,640,252 and U.S. Pat. No. 5,359,207. The disclosures of each of these United States patents are hereby incorporated herein by reference.

After vacuum head 442 has acquired fluffed leaf 39, motors 451, 452, and 454 are operated to effect the turning of a page. Motors 451 and 454 control the angular and radial positions of the vacuum head 442 such that a substantially arcuate trajectory of vacuum head 442 results, as indicated by arcuate arrow 499. As such arcuate trajectory occurs, motor 452 is operated such that the lower portion 484 of vacuum head 442 is maintained substantially parallel with fluffed leaf 39, as it is being turned. In this manner, the page turning operation does not put the page being turned into a highly curved configuration. Such a high degree of curvature would produce bending stresses in the page, possibly damaging the page, or causing the page to become detached from vacuum head 442. Instead, the page is maintained in a substantially planar configuration, or with an involute profile, as it is turned, such that minimal bending or tensile stress is produced in the page as it is turned, i.e. substantially pivotally moved about its bound edge.

Referring to FIG. 16A, and by way of further illustration, the operation of motor 452 during page turning is described qualitatively in terms of phi angle. At the commencement of page turning, when vacuum head 442 has acquired fluffed leaf 39, the phi angle of vacuum head 442 is approximately 30 degrees in the embodiment depicted in FIG. 16A. At the halfway point of page turning (not shown), i.e. when the turning leaf is substantially vertical, the phi angle of vacuum head 442 is approximately 90 degrees. Accordingly, lower portion 484 of vacuum head 442 is substantially vertical. Nearing the completion of page turning (not shown), the turned leaf is nearing the angle of the former verso page 36 of book 10. The phi angle of vacuum head 442 at this point in the cycle is approximately 130 degrees. In other words, vacuum head 442 “rolls over” during the turning of a page, such that the lower portion 484 of vacuum head 442 faces diagonally downward at the beginning of page turning as depicted in FIG. 16A, to being substantially vertical at the halfway point of page turning, to facing diagonally upward near the completion of page turning.

Referring to FIG. 15B, when page turning is nearly complete and vacuum head 442 is proximate to the former verso page 36, vacuum valve 465 is closed, resulting in the release of leaf 39 from vacuum head 442. Vacuum head is moved further out beyond the field of view of the camera (not shown), wherein the page turning cycle is complete and the next imaging cycle can begin. It will be appreciated that in a typical cycle, the vacuum is kept on as the page is turned, allowing the clamps to come down and hold the pages in position as the vacuum head completes its cycle. Furthermore, a vacuum sensor may be employed to sense when, after turning the page, the vacuum head begins to loose contact with the page and to confirm that it is okay for the clamps to begin to move into clamping position. In this sense, the vacuum sensor may be used as a sensor to determine if the page has been turned appropriately. However, there may arise situations where the vacuum sensor cannot be used to initiate the clamping, such as loose pages or torn pages of a bound document, where the vacuum would not be broken when the vacuum head 442 moves upward. In these situations the vacuum is preferably turned off so as to avoid moving a loose page out and/or eliminating further tearing of a partially torn page.

In the operation of page turner 440, proximity sensors 484, 485, 486, and 487 enable the setting of the zero positions of motors 451, 452, and 454 at the beginning of a book imaging process. In this manner, the variation in book sizes (i.e. width and thickness) is accommodated.

To summarize, page turner 440 replicates substantially the same page motions in turning a page as performed by a human reader.

In another embodiment, the page turning assembly may further comprise an air knife, which is used to fully separate the top fluffed leaf from any additional leaves that may have been displaced from the text block by the fluffer. Such air knives are known in the art of sheet feeding of paper sheets in electrophotographic copiers and printers. Refer, for example, to U.S. Pat. No. 6,279,896 of Linder et al., the disclosure of which is incorporated herein by reference.

FIGS. 16A and 16B depict one embodiment of a page turning assembly, further comprising an air knife. Referring to FIG. 16A, air knife 610 comprises a plenum chamber 612, an inlet port 614, and at least one nozzle 616 directed toward the outer edge of fluffed leaf 39. Air knife 610 is suitably mounted upon an additional supporting structure (not shown) of the apparatus. Pressurized air is supplied to the inlet port 614 of air knife 610, and passes through the plenum 612, and out of nozzle 616. Nozzle 616 is preferably directed at an angle with respect to text block 30 of book 10, as depicted in FIG. 16A, in order to most effectively separate additional fluffed leaves (not shown) from top fluffed leaf 39 of book 10.

Pressurized air is preferably provided to air knife 610 by a blower (not shown). In one embodiment (not shown), a manifold is provided, and the blower 423 of FIG. 14B is operatively connected by tubing and fittings to air knife 610, such that blower 423 supplies air to fluffer 410 of FIG. 14B, and to air knife 610 if FIG. 16B.

In one preferred embodiment shown in FIG. 16B, air knife 610 comprises a pair of nozzles 616 and 618, disposed at approximately a 45 degree angle to the outer edge 41 of fluffed leaf 39. The air streams of nozzles 616 and 618, indicated by arrows 620 and 622 respectively, converge in proximity to outer edge 41 of fluffed leaf 39, and more effectively separate additional fluffed leaves (not shown) from top fluffed leaf 39 of book 10. Thus, in the embodiments described, the page turning apparatus uses an air knife to separate a top page from adjacent pages, thereby preventing or avoiding the turning of multiple pages at one once.

In yet a further embodiment, the page turning assembly further comprises retard fingers (see e.g., FIG. 13C), which are used to block or retard the movement of any additional leaves that may have been displaced from the text block by the fluffer, during the page turning cycle. It is known that at high page turning speed and short cycle times, when a page is turned rapidly, it creates a vacuum, which draws on the next leaf, or several leaves, in sequence. If such leaf has been separated sufficiently by the fluffer, this induced vacuum may cause this next leaf to be turned, as well as the intended leaf. If such a scenario occurs, the effect in image acquisition of book pages is to skip at least one pair of pages, which is clearly undesirable. Accordingly, retard fingers are used to prevent such an undesired operation.

FIG. 16B depicts one preferred embodiment of retard fingers. Referring to FIG. 16B, retard fingers 630 and 640 are disposed at the corners 44 and 45, respectively, of book 10. Retard finger 630 is operatively joined to shaft 632 of motor 634. In like manner, retard finger 640 is operatively joined to shaft 642 of motor 644. Motors 634 and 644 are suitably mounted on additional supporting structure (not shown) of the apparatus. Operation of motor 634 in the counterclockwise direction will deploy retard finger 630, and operation of motor 634 in the clockwise direction will retract retard finger 630, as indicated by arcuate arrow 636. In like manner, operation of motor 644 in the clockwise direction will deploy retard finger 640, and operation of motor 644 in the counterclockwise direction will retract retard finger 640, as indicated by arcuate arrow 646. In the execution of the page turning cycle, retard fingers 630 and 640 are deployed immediately prior to the operation of the page turner 440 of FIG. 16A, the operation of which has been previously described.

In another embodiment, the disclosed system further comprises page edge detection means. A variety of known devices are suitable as page edge detection means. In functional terms, any optical, mechanical, or electrical device, or combination thereof, which can detect the discontinuity between air and the edge of a piece of paper is suitable. In one embodiment, page edge detection means comprises an optical device, with one preferred embodiment including a phototransistor array. One suitable phototransistor array is manufactured by Optek Technology, Inc. of Carrollton, Tex., and sold as Type OPR5013. This Optek phototransistor array comprises a multi element light emitting diode array having approximately thirteen elements, with 0.027 inch resolution per element.

In one embodiment, depicted in FIG. 20, the phototransistor array is mounted upon the vacuum head so that it can be verified that the page being turned remains attached to the vacuum head during the entire page turning cycle. Referring to FIG. 20, phototransistor array 650 is suitably mounted upon surface 441 of vacuum head 442. Phototransistor array 650 is mounted such that it protrudes outwardly from surface 441 in a direction such that the array of individual elements 652 is substantially parallel to lower portion 484 of vacuum head 442. Accordingly, phototransistor array elements 652 are substantially parallel to fluffed leaf 39 of book 10.

Phototransistor array 650 further comprises photodetection means (not shown) for each element 652 of phototransistor array 650. Such photodetection means are well known and are provided, e.g., in the phototransistor array of Optek Technology previously described. Thus, if the edge of a substantially light reflecting surface is placed in proximity to phototransistor array 650, a signal may be provided from each element 652 and corresponding photodetection means to indicate if the light reflecting surface is proximate to each individual element 652. Thus the location of the edge of a light reflecting surface may be determined to a level of precision approximately equal to the distance between the individual elements 652.

Such is the basis for the use of a phototransistor as page edge detection means. Referring to FIG. 20, the fore-edge 26 of fluffed leaf 39 is determined by phototransistor array 650 to be located between element 654 and element 656. Element 656 and adjacent elements towards vacuum head 442 detect the presence of fluffed leaf 39, and elements 654 and adjacent elements away from vacuum head 442 detect the absence of fluffed leaf 39.

Such page edge detection means are useful in detecting the edge of the fluffed leaf 39 prior to and during the page turning cycle. In this manner, the acquisition and retention of the fluffed leaf 39 by the vacuum head 442 may be confirmed throughout the page acquisition and page turning cycle. The use of page edge detection is particularly valuable when imaging a book that is significantly prone to page foreshortening over the course of imaging the book pages seriatim, as previously described herein. Such page edge detection significantly improves the capability of the apparatus to accommodate books of varying geometry and spine properties.

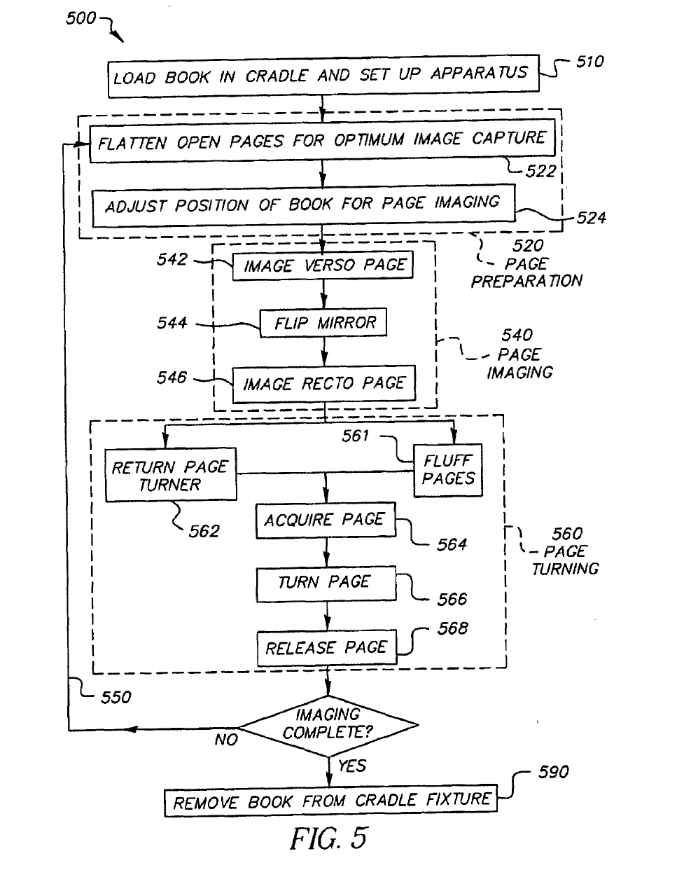

The overall operation of the apparatus wherein images of the pages of a book are viewed and/or recorded is now described. FIG. 5 is a flow chart of an automated process for acquiring images of the pages of a book, using embodiments described herein. Referring to FIG. 5, process 500 begins with step 510, the loading of a book and setup of the apparatus, and ends with step 590, the removal of the book from the cradle of the apparatus. Steps 510 and 590 are manual steps performed by an operator. Step 510 comprises placing the book upon the cradle and affixing slidable clamps to the edges of the book (previously described in this specification). Step 510 further comprises initial adjustments and optimization of sensors, optical and mechanical components, imaging software algorithms, etc., in order to accommodate the particular height, width, and thickness of the book, and to obtain clear, complete, and focused images of the pages throughout the imaging process. Step 590, the removal of the book, comprises the releasing of the slidable clamps of the cradle from the edges of the book, and lifting the book from the cradle.

Between steps 510 and 590 of the process 500, there occurs an overall repetitive cycle 550, which further comprises the sequential cycles of page preparation 520, page imaging 540, and page turning 560. Overall repetitive cycle 550 occurs until the final page of the book has been imaged.

Page preparation cycle 520 comprises page flattening step 522 and page position adjustment step 524. Page flattening step 522 is performed by the deployment of front page clamping assembly 140 and rear page clamping assembly 160 of FIGS. 9A through 11B, as previously described in this specification. Page position adjustment step 524 is performed by the operation of cradle drive motors 220 and 270 to independently adjust the positions of left cradle half 210 and right cradle half 260 as previously described in this specification. Adjustment step 524 may further comprise the adjustment of the x-position of the cradle assembly to position the bifurcation between opposed pages and thereby “center” the document for imaging.

Page imaging cycle 540 comprises verso page imaging step 542, mirror flipping step 544, and recto page imaging step 546. Verso page imaging, flip mirror operation, and recto page imaging are performed as previously described in this specification and shown of FIGS. 12A and 12B.

Page turning cycle 540 comprises page fluffing step 561 performed concurrently with page turner return step 562, page acquisition step 564, page turning step 566, and page releasing step 568. Page fluffing step 561 is performed by the operation of page fluffer 410 of FIGS. 13A through 14B, as previously described in this specification. Page turner return step 562 is performed by operating drive motors 452 and 454 of page turner 440 of FIGS. 15A and 15B, as previously described in this specification, in order to return vacuum head 442 from a position above and to the left of book 10 (where it was parked after the previous page turning cycle), to a position in close proximity to fluffed leaf 39. Page acquisition step is performed by the operation of a vacuum pump and valve, which are suitably operably connected to vacuum head 442, such that fluffed leaf 39 is drawn and secured against vacuum head 442; and by operation of air knife 610 of FIGS. 16A and 16B, as previously described in this specification. Page turning step is performed by deploying retard fingers 630 and 640 of FIG. 16 by motors 634 and 644, respectively; and by operating drive motors 451, 452, and 454 of page turner 440 of FIGS. 15A and 15B, such that fluffed leaf 39 is turned from the right portion of the open book to the left portion of the open book, as previously described in this specification. Page releasing step 568 is performed by the closing of a vacuum valve, so that vacuum within vacuum head 442 is relieved, and the turned leaf is released, as previously described in this specification.

Upon completion of the page turning cycle, the apparatus determines whether or not all of the pages of the book have been imaged, and if not, repetitive cycle 550 is repeated. In one embodiment, the apparatus simply detects a fault in page acquisition and shuts down, awaiting operator intervention. (A fault will always occur in page acquisition when there are no additional pages to be acquired and imaged.)

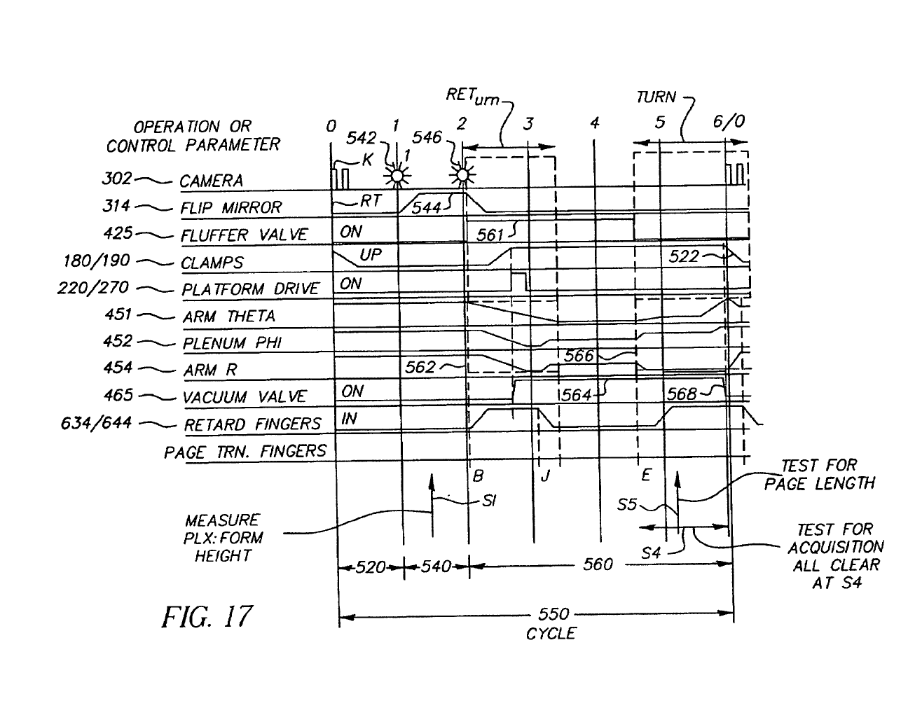

In one embodiment, repetitive cycle 550 takes approximately six seconds to complete, resulting in a page-imaging rate of approximately twenty pages per minute. Accordingly, a textbook of five hundred pages is imaged by the apparatus in approximately twenty five minutes. FIG. 17 is an exemplary timing diagram of the embodiment having approximately a six second repetitive cycle, which depicts the relative timing of the operation of key components of the apparatus during repetitive cycle 550. Referring to FIG. 17, repetitive cycle 550 occurs in approximately six seconds, and comprises page preparation cycle 520 occurring from zero to about 1.0 seconds, page imaging cycle 540 occurring from about 1.0 seconds to 2.1 seconds, and page turning cycle occurring from about 2.1 seconds to 6.0 seconds. In practice, the operation of the components performed to execute cycles 520, 540, and 560 may overlap slightly due to response times (e.g. acceleration and deceleration of motors) of components.

Referring again to FIG. 17, in page preparation cycle 520, “Clamps” operation occurs by the operation of page clamp motors 180 and 190, which deploy page clamp assemblies 140 and 160, as previously described in this specification and shown in FIGS. 9A through 11B. Deployment of page clamp assemblies 140 and 160 starts at time zero, and takes approximately 0.4 seconds. In page imaging cycle 540, camera 302 executes the verso page imaging step 542 at approximately 1.05 seconds, as indicated by the flash icon 542. Flip motor 314 executes mirror flipping step 544 between approximately 1.1 and 1.5 seconds. Subsequently, camera 302 executes the recto page imaging step 546 at approximately 2.05 seconds, as indicated by the flash icon 546. Flip motor 314 then reverses mirror flipping step 544 between approximately 2.1 and 2.5 seconds, returning flip mirror to the verso page imaging position.

A number of components are operated simultaneously to execute the steps comprising page turning cycle 560. Page clamp assemblies 140 and 160 are immediately retracted by the operation of page clamp motors 180 and 190, during the time of approximately 2.1 to 2.6 seconds. Fluffer valve 425 is actuated, executing page fluffing step 561 from the time of about 2.1 to 4.8 seconds. In an embodiment of the apparatus comprising an air knife (not shown), such air knife is operated as part of the execution of page fluffing step 561. Retard finger drive motors 634 and 644 deploy retard fingers 630 and 640 at approximately 2.2 seconds. Arm theta control drive motor 451, vacuum head plenum phi control drive motor 452, and arm R drive motor 454 begin operation at approximately 2.1, 2.3, and 2.4 seconds respectively, and operate until approximately 3.5 seconds, to execute return page turner step 562. Vacuum valve 465 is opened at approximately 2.6 seconds, drawing the fluffed leaf to the vacuum head and thereby executing page acquisition step 564. Arm theta control drive motor 451, vacuum head plenum phi control drive motor 452, and arm R drive motor 454 resume operation at approximately 4.8 seconds with vacuum valve 465 remaining open, and operate until approximately 5.9 seconds, to execute turn page turner step 566. At time of approximately 5.9 seconds, vacuum valve 465 is closed, executing the release page step. As the cycle begins again with page flattening step 520, theta control drive motor 452, and R drive motor continue operation for approximately 0.3 seconds, moving the page turner to the left of the book and out of the field of view of the camera, while retard finger motors 634 and 644 retract retard fingers 630 and 640. Repetitive cycle 550 continues if the final pages have not been imaged.

It is to be understood that the apparatus provides significant advantages. In particular, the adjustable book securing components of the cradle assembly accommodate the dimensional variability from book-to-book. The independent adjustment of the position of each cradle half of the cradle assembly accommodates the variation in page location during the transition of open page location from the front of the book to the back of the book, as the pages are turned seriatim from the first page to the last page.

Thus, each pair of open pages of a book is presented to the page clamping and page imaging systems in the same three-dimensional location, enabling the apparatus to obtain a clear, complete, and focused image of each page, regardless of the location of the open pages within the book. Furthermore, each fluffed leaf is presented to the page turning assembly in exactly the same three-dimensional location, enabling the apparatus to reliably turn each page, regardless of the location of the open pages within the book. For each page preparation cycle 520, page imaging cycle 540, and page turning cycle 560, no in situ adjustment of various components is needed to accommodate book variation. Adjustments of the apparatus are made once as part of a setup procedure at the beginning of the book imaging process in step 510 of FIG. 5. Such capability of the apparatus enables the overall repetitive cycle 550 of FIGS. 5 and 17 to be completed through the imaging of an entire book.

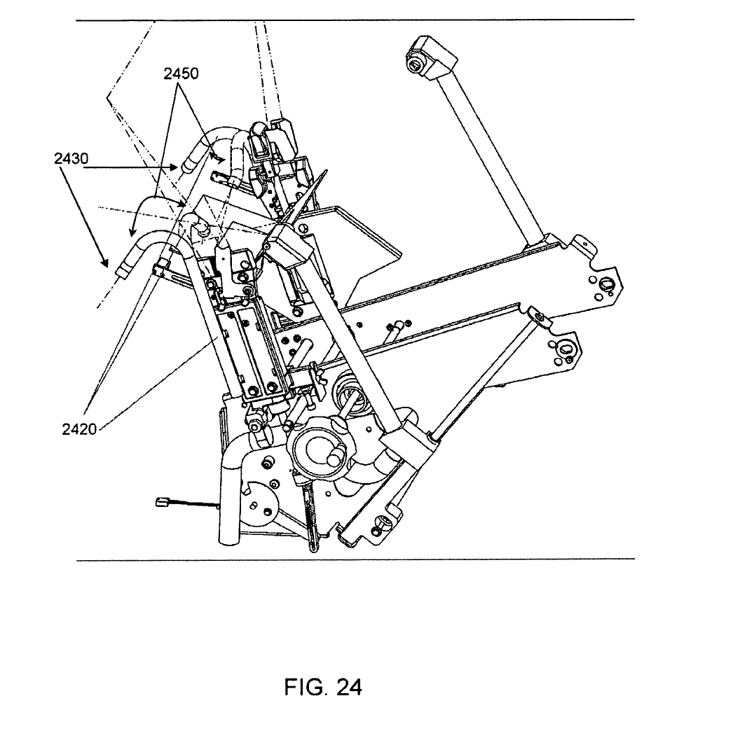

In another embodiment, the disclosed page turning apparatus may further include one or more means for page flattening or smoothing in order to improve the viewing or imaging of the pages. In one alternative, the page flattening means is intended to eliminate air between pages that have been turned, thereby resulting in the smoothing of the pages. Various alternatives are contemplated with respect to such page flattening means, including, for example, the application of mechanical force to the top (turned) page; also to a non-turned page, which may have been disrupted by the turning of a prior page. One method for applying a mechanical force is through various contact-type means such as a roller that rolls the pages (e.g. from the spine toward the outer edges, or across the page in a top-to-bottom or vice versa direction), windshield wiper like blade that is swept over the page surface (e.g., from the spine outward and pivoting about a location near the bottom spine edge), etc. In another embodiment, non-contact means are employed for assuring flattened or smoothed pages are obtained. For example, referring to FIG. 24, there is depicted an exemplary embodiment of an air-jet system or pneumatic flattening means for flattening the pages. Such a system includes air delivery tubes 2420, supplying air at an increased pressure to one or more jets 2430 located at or near the end of such tubes. The air jets operate to provide a pulse or continuous stream of air over the surface of the page (recto or verso), and thereby to force the page into a position with the page below (removing air between the page sheets).

As depicted by arrows 2450 in FIG. 24, the air tubes (and associated jets) may be pivoted or otherwise moved between an inward directed operative position and an outward (or parallel with the book edge) position so that the air tubes and jets do not interfere with page turning or imaging/view of the pages. Although not depicted in the operational timing diagram of FIG. 17, it will be appreciated that the various operations of the air jets (pivoting inward, applying pressurized air to flatten the pages, and swinging back to a retracted position, will occur in conjunction with the operation of other machine components to assure the flattening of the pages—preferably before clamping forces are applied to the sheets.

As yet another alternative for a non-contact embodiment, the use of electrostatic forces may be considered to assure page flattening. In such an embodiment, the “spraying” of charges or otherwise creation of charges that attract adjacent page surfaces may be employed to encourage the pages to settle or flatten when turned.

As illustrated by FIGS. 22B and 23D-E, the photodiode sensors may be employed not only for sensing the page bifurcation location, but may also be used as page clear sensors, to assure that a turned page (or other disrupted page) is out of the way before the page clamps are applied adjacent the page bifurcation region. In the depicted embodiment, the cross-beam sensors 255 and 2255 may be mounted on the clamp assemblies 140 and 160 themselves.

The disclosed system and apparatus further contemplates the possibility of operation as an oversize book scanner. In such an embodiment, the cradle halve are preferably altered in a manner permitting the support plates 212 to be extended in an upward and outward direction—either by larger-sized plates, by extensions that fit on the depicted plates as well as by other manual or automated means that can be adjusted to support larger format documents. Moreover, such an alternative also contemplates the need to adjust the optics of the imaging system in order to accommodate and acquire larger format images. One possible design includes a folded optical system, wherein mirrors or similar optical devices are employed to effectively increase the length of the optical path. Moreover, the illumination source(s) may need to be changed or altered to assure the proper, and consistent, illumination over the oversized pages. Such a system may employ or rely on photographic illumination devices including lighting, baffles and the like in order to assure consistent illumination.

It is, therefore, apparent that there has been provided, in accordance with the disclosure herein, a method and apparatus for the acquisition and recording of book page images seriatim, comprising a cradle assembly, an optical assembly, and a page turning assembly. While the system, apparatus and methods has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. An apparatus for turning pages of a document, comprising:
a base for supporting the operative assemblies and components of the apparatus;
a cradle assembly for supporting the document therein, said cradle assembly being automatically adjustable, in response to a bifurcation location signal produced from a sensor, so as to enable the centering of a document supported therein;
a page turning assembly for moving the pages to be viewed in seriatim, wherein the page turning assembly includes an adjustable vacuum head, said head being adjustable between at least a first position and a second position;
at least one variable-position page fluffer, movable along at least one of the top and bottom edges of the pages;
a page snubber for preventing the turning of multiple pages in a single page-turning cycle;
at least one page-flattening means for flattening pages of the document; and
at least one page clamp, movable between a first position, outside of a volume defined by a turning page, and a second position within said volume so as to clamp pages that have been flattened.

2. The apparatus according to claim 1, wherein said page-flattening means are pneumatic.

3. The apparatus according to claim 2, wherein said pneumatic page-flattening means are co-located on a common assembly with the page clamps.

4. The apparatus according to claim 1, wherein said page snubber is operatively associated with said variable position page fluffer.

5. The apparatus according to claim 1, wherein said page snubber includes a plurality of spaced-apart fingers for contacting at least a corner of pages being turned.

6. The apparatus according to claim 1, wherein said bifurcation location signal is produced as a result of the output from a photodiode.

7. The apparatus according to claim 1, further including a page-clear sensor for indicating when the turned page has been moved beyond a predetermined point.

8. An apparatus for turning pages of a document, comprising:
a base for supporting the operative assemblies and components of the apparatus;
a cradle assembly for supporting the document therein, said cradle assembly being automatically adjustable, in response to a bifurcation location signal, so as to enable the centering of a document supported therein; and
a page turning assembly for moving the pages to be viewed in seriatim.

9. The apparatus according to claim 8, wherein said bifurcation location signal is produced as a result of the output from a photodiode.

10. The apparatus according to claim 8, wherein said bifurcation location signal is produced in response to the output from a photodiode array.

11. The apparatus according to claim 8, wherein said bifurcation location signal is produced in response to image signals generated by a charge-coupled device.

12. The apparatus according to claim 11, wherein image signals are employed to provide additional information selected from the group consisting of: the profile of the document spine, indication that a page has not been completely turned, and the presence of spine foreshortening of the pages.

13. The apparatus according to claim 8, wherein the page turning assembly includes an adjustable vacuum head, said head being adjustable between at least a first position and a second position.

14. An apparatus for turning pages of a document, comprising:
a base for supporting the operative assemblies and components of the apparatus;
a cradle assembly for supporting the document therein;
a page turning assembly for moving the pages to be viewed in seriatim; and
a snubber, moving between an operative position and a retracted position, to prevent a subsequent page from turning when the snubber is in the operative position.

15. The apparatus according to claim 14, wherein said snubber includes at least one flexible finger.

16. The apparatus according to claim 14, wherein said snubber includes a plurality of spaced-apart, flexible fingers positioned to interfere with at least a corner of a page being moved.

17. The apparatus according to claim 14, wherein said flexible fingers are thinner at the tip than at the base.

18. An apparatus for turning pages of a document, comprising:
a base for supporting the operative assemblies and components of the apparatus;
a cradle assembly for supporting the document therein;
a page turning assembly for moving the pages to be viewed in seriatim; and
pneumatic means for flattening the pages after turning.

19. The apparatus of claim 18, wherein said page flattening means includes at least one air jet.

20. The apparatus of claim 19, wherein said air jet is operatively associated with a page clamping assembly.

21. The apparatus of claim 20, wherein said air jet further operates a pivoting deflector that deflects air from the air jet toward the surface of the pages.

22. The apparatus of claim 18, further comprising sensors for detecting the boundaries of pages.

23. The apparatus of claim 18, further comprising a page-clear sensor for indicating when the turned page has been moved beyond a predetermined point.
